(19) United States
(12) Patent Application Publication
(10) Pub. No.: US 2020/0327744 A1
(43) Pub. Date: Oct. 15, 2020

(54) INFORMATION PROCESSING SYSTEM AND INFORMATION PROCESSING PROGRAM

(71) Applicant: TOYOTA JIDOSHA KABUSHIKI KAISHA, Toyota-shi (JP)

(72) Inventor: Kazumi AONO, Toyota-shi (JP)

(73) Assignee: TOYOTA JIDOSHA KABUSHIKI KAISHA, Toyota-shi (JP)

(21) Appl. No.: 16/812,525

(22) Filed: Mar. 9, 2020

(30) Foreign Application Priority Data
Apr. 11, 2019 (JP) 2019-075419

(51) Int. Cl. G07C 5/02; G06K 9/00; G10L 25/51; G06T 7/50

(52) U.S. Cl. CPC G07C 5/02; G06K 9/00805; G06T 2207/10028; G06T 7/50; G06T 2207/30261; G10L 25/51

(57) ABSTRACT

An information processing system is equipped with a ranging unit that measures a distance from a vehicle to an object existing around the vehicle, a sound collection unit that collects a sound around the vehicle, a sound pressure level detection unit that detects a sound pressure level representing an intensity of the sound, a contact detection unit that detects a contact of the vehicle with the object when the sound pressure level that is detected when the distance is equal to zero becomes higher than a predetermined threshold, and a user specification unit that specifies a user of the vehicle of which the contact has been detected, based on user identification information for identifying the user of the vehicle, when the contact is detected.

### INCORPORATION BY REFERENCE

The disclosure of Japanese Patent Application No. 2019-075419 filed on Apr. 11, 2019 including the specification, drawings and abstract is incorporated herein by reference in its entirety.

### BACKGROUND

### 1. Technical Field

The disclosure relates to an information processing system and an information processing program.

### 2. Description of Related Art

A share car is lent and returned without the intermediary of a manager. Therefore, a user of each vehicle informs the manager, on a self-reporting basis, whether or not there is a scratch on the vehicle, or it is confirmed through a periodic inspection by the manger whether or not there is a scratch on the vehicle. The share car means a vehicle that is shared by a plurality of persons at different timings via, for example, a car sharing service, a rental car service or the like. In Japanese Patent Application Publication No. 05-066228 (JP 05-066228 A), there is disclosed an art of detecting that a vehicle has collided with an obstacle. In the conventional art disclosed in Japanese Patent Application Publication No. 05-066228 (JP 05-066228 A), a pressure is detected by pressure detection means that is installed in a sealed region between an outer panel and an inner panel of a door, and it is detected that the vehicle has collided with the obstacle, when the pressure is equal to or higher than a predetermined value.

### SUMMARY

As described previously, as for the share car, the user informs the manager, on a self-reporting basis, whether or not there is a scratch on the vehicle, or it is confirmed, through the periodic inspection by the manager, whether or not there is a scratch on the vehicle. Therefore, when there is a scratch on the vehicle, it is unknown which one of a plurality of users who utilized the vehicle scratched the vehicle. Accordingly, there is an apprehension that the locus of responsibility may become unclear. In the conventional art disclosed in Japanese Patent Application Publication No. 05-066228 (JP 05-066228 A), it can be detected, based on the pressure detected by the pressure detection means, that the vehicle has collided with the obstacle. However, in the case of a collision that cannot be detected by the pressure detection means, for example, a slight contact of the vehicle running at low speed in a self-propelled parking lot with a guardrail or the like, the vehicle is often not seriously damaged. Therefore, the user who was driving the slightly scratched vehicle cannot be specified. As a result, there is a problem in that the locus of responsibility cannot be clarified.

The disclosure has been made in view of the foregoing point, and it is an object of the disclosure to clarify the locus of responsibility even when a vehicle is scratched.

In order to solve the above-mentioned problem, an information processing system according to an aspect of the disclosure is equipped with a ranging unit that measures a distance from a vehicle to an object existing around the vehicle, and a sound collection unit that collects a sound around the vehicle. The vehicle management system is equipped with a sound pressure level detection unit that detects a sound pressure level representing an intensity of the sound, and a contact detection unit that detects a contact of the vehicle with the object when the sound pressure level that is detected when the distance is equal to zero becomes higher than a predetermined threshold. The vehicle management system is equipped with a user specification unit that specifies a user of the vehicle of which the contact has been detected, based on user identification information as information for identifying the user of the vehicle, when the contact is detected.

According to the present aspect, the contact detection unit can detect that the vehicle running at low speed has come into slight contact with the object, by having the determination result indicating that the sound pressure level has become higher than the predetermined threshold input thereto, with the distance from the vehicle to the object being equal to zero. Besides, the user of the vehicle at the time of the occurrence of such a contact can be managed in a linked manner. Accordingly, the user of the vehicle that has come into slight contact with the object can be specified. Therefore, the user who was driving the vehicle slightly scratched while running at low speed can be specified, the locus of responsibility can be clarified, and the other users can be prevented from being falsely accused.

Besides, in the present aspect, the user specification unit may associate timing information indicating a timing of detection of the contact with the user specification information as the information for specifying the user of the vehicle of which the contact has been detected, and store the timing information associated with the user specification information into the storage unit.

According to the present aspect, by associating the timing of detection of the contact with the user specification information, the manager of, for example, the car share service or the rental car service not only can easily specify the user who was driving the vehicle at the time of the occurrence of the contact, but also prevents the users other than the user who was driving the vehicle at the time of the occurrence of the contact from being falsely accused, through confirmation of the timing stored in the user specification information storage unit.

Besides, in the present aspect, a contact sound specification unit that analyzes the sound collected by the sound collection unit and that specifies a contact sound of the vehicle with the object may be further provided. The contact detection unit may detect the contact when the sound pressure level that is detected when the distance is equal to zero becomes higher than the predetermined threshold and the contact sound is specified.

According to the present aspect, by extracting the contact sound including no disturbing sound, the accuracy in detecting the contact is made higher than in the case where only the process of making a determination on the sound in accordance with the sound pressure level is utilized. Therefore, even in the case where the sound pressure level has become higher than the predetermined threshold because of, for example, the closure of a door of another vehicle adjacent to the vehicle that is moving backward to be parked, when no contact is detected in the contact sound specification information, the vehicle moving backward is not in contact with the object existing around the vehicle. Accordingly, it turns out that the user of the vehicle is not responsible.

Besides, in the present aspect, an acceleration detection unit that detects an acceleration of the vehicle, and an acceleration determination unit that determines whether or not the acceleration has become larger than a predetermined threshold may be further provided instead of the sound pressure level detection unit. The contact detection unit may detect the contact when the acceleration becomes larger than the predetermined threshold, instead of a case where the sound pressure level becomes higher than the predetermined threshold.

According to the present aspect, the acceleration that is detected when it is determined that the distance is equal to zero can be utilized. Therefore, when a large acceleration is detected because a part of the vehicle that is difficult to visually recognize has hit a curbstone or a step portion, the user specification information can be recorded. Accordingly, even in the case where a lateral surface, a rear bumper or the like of the vehicle is not scratched, the manager of share cars or the like can conduct an inspection of at least the part that is difficult to visually recognize, and take a measure such as a repair or the like of the vehicle, by being informed that the user specification information is recorded.

Besides, in the present aspect, an imaging unit that images an outer peripheral portion of the vehicle may be further provided. The user specification unit may associate imaging data imaged by the imaging unit with the user specification information as the information for specifying the user of the vehicle of which the contact has been detected, and store the imaging data associated with the user specification information into the storage unit.

According to the present aspect, the imaging data at the time of detection of the contact can be left. For example, when a disturbing sound with a frequency close to a frequency band of the contact sound is produced around the vehicle, the occurrence of a contact may be erroneously detected. In an information processing system according to a second modification example, an image at the time of erroneous detection of the contact sound can be left. Therefore, by confirming this image, it turns out that the user is not responsible. Besides, the image at the time of the actual occurrence of the contact can be confirmed, so the manager of share cars or the like can immediately confirm the part that has come into contact with the object. Therefore, the time required for the manager to check is shortened, and the costs of operating a sharing service can be reduced.

Besides, in the present aspect, a server that stores the user specification information as the information for specifying the user of the vehicle of which the contact has been detected may be further provided.

According to the present aspect, information can be shared at respective bases where the sharing service is operated. Accordingly, the car that has come into contact with the object can be immediately confirmed. Therefore, the time required for the manager of share cars or the like to check is shortened, and the costs of operating the sharing service can be significantly reduced.

Besides, in the present aspect, an in-vehicle machine that stores the user specification information as the information for specifying the user of the vehicle of which the contact has been detected may be further provided.

According to the present aspect, the user specification information recorded in the in-vehicle machine can be confirmed via, for example, a screen of a navigation device or the like. Also, the amount of communication resources can be restrained from decreasing, by uploading the user specification information to the management server, and downloading the user specification information from the management server to the respective bases where the sharing service is operated, etc. Thus, the costs of operating the sharing service can be restrained from rising.

Besides, another aspect of the disclosure can be realized as an information processing program.

The disclosure has an effect of making it possible to clarify the locus of responsibility even when the vehicle is scratched.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view showing a configuration example of an information processing system 1 according to one of the embodiments of the disclosure;

FIG. 2 is a view showing a configuration example of a management server 10;

FIG. 3 is a view showing an example of a user information DB 131;

FIG. 4 is a view showing an example of a reservation information DB 132;

FIG. 5 is a view showing an example of a use history information DB 133;

FIG. 6 is a view showing a configuration example of an in-vehicle machine 200;

FIG. 7 is a view for illustrating an example of detection regions of clearance sonars and an example of a detection region of radar sensors;

FIG. 8 is a view showing an example of an operation method difference information DB 231;

FIG. 9 is a view showing an example of a function information DB 234;

FIG. 10 is a view showing an example of a vehicle information acquisition unit 270;

FIG. 11 is a view showing a configuration example of a portable terminal 30;

FIG. 12 is a view showing an example of a terminal information acquisition unit 370;

FIG. 13 is a view showing an example of an operation flow of the portable terminal 30 at the time of reservation;

FIG. 14 is a view showing a first operation flow of the management server 10 at the time of reservation;

FIG. 15 is a view showing a second operation flow of the management server 10 at the time of reservation;

FIG. 16 is a view showing a third operation flow of the management server 10 at the time of reservation;

FIG. 17 is a sequence chart for illustrating an operation of specifying a user of a vehicle that has come into contact with an object existing around the vehicle;

FIG. 18 is a flowchart for illustrating the operation of specifying the user of the vehicle that has come into contact with the object existing around the vehicle;

FIG. 19A is a first view for illustrating a ranging operation and a distance determination operation;

FIG. 19B is a second view for illustrating the ranging operation and the distance determination operation;

FIG. 20 is a view for illustrating an operation of making a determination on a sound pressure level by a sound pressure level detection unit 119;

FIG. 21 is a view showing a first modification example of the information processing system 1 according to the present embodiment;

FIG. 22 is a sequence chart for illustrating the operation of specifying the user of the vehicle that has come into contact with the object existing around the vehicle in the information processing system 1 according to the first modification example;

FIG. 23 is a flowchart for illustrating the operation of specifying the user of the vehicle that has come into contact with the object existing around the vehicle in the information processing system 1 according to the first modification example;

FIG. 24 is a view showing a second modification example of the information processing system 1 according to the present embodiment;

FIG. 25 is a sequence chart for illustrating the operation of specifying the user of the vehicle that has come into contact with the object existing around the vehicle in the information processing system 1 according to the second modification example;

FIG. 26 is a flowchart for illustrating the operation of specifying the user of the vehicle that has come into contact with the object existing around the vehicle in the information processing system 1 according to the second modification example;

FIG. 27A is a first view showing a landscape that is imaged by an imaging unit 420;

FIG. 27B is a second view showing the landscape that is imaged by the imaging unit 420;

FIG. 28 is a view showing a third modification example of the information processing system 1 according to the present embodiment;

FIG. 29 is a sequence chart for illustrating the operation of specifying the user of the vehicle that has come into contact with the object existing around the vehicle in the information processing system 1 according to the third modification example;

FIG. 30 is a flowchart for illustrating the operation of specifying the user of the vehicle that has come into contact with the object existing around the vehicle in the information processing system 1 according to the third modification example; and

FIG. 31 is a view for illustrating an operation of making a determination on an acceleration by an acceleration determination unit 440.

### DETAILED DESCRIPTION OF EMBODIMENTS

Modes for carrying out the disclosure will be described hereinafter with reference to the drawings.

### EMBODIMENTS

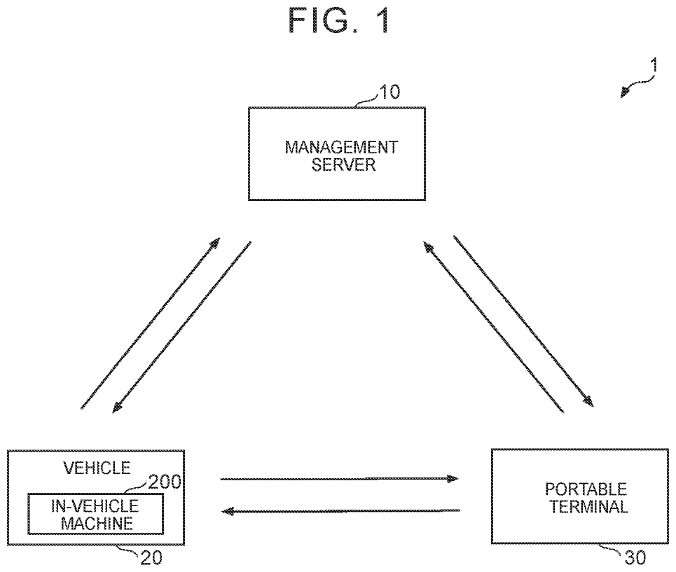

FIG. 1 is a view showing a configuration example of an information processing system 1 according to one of the embodiments of the disclosure. In the present embodiment, there is presented an example in which the information processing system 1 is applied to a car sharing system. The car sharing system is a system for allowing a plurality of users to use one or a plurality of vehicles 20 based on prior reservations. In the car sharing system, each of the users accesses a management server 10 and reserves the use of one of the vehicles 20, through the use of a portable terminal 30. The vehicle 20 that is used by the user appropriately guides the user through the establishment of communication with the management server 10 and the portable terminal 30 by an in-vehicle machine 200 of the vehicle 20.

Incidentally, the information processing system 1 according to the present embodiment may not necessarily be the car sharing system, but is applicable to a rental car system for lending a plurality of cars to unspecified users. Besides, the information processing system 1 according to the present embodiment is also applicable to a system for sharing information on the vehicle 20 first owned and then left by a user and another vehicle 20 newly used by the user. Each of the vehicles 20 may not necessarily be a passenger car, but may be a freight car, a share-ride car (e.g., a bus) or the like. In the following description, the vehicle 20 may be referred to simply as “the vehicle” or “the car”. For the sake of simplification of explanation, the present embodiment will be described on the assumption that the information processing system 1 is a system for car sharing.

As shown in FIG. 1, the information processing system 1 is equipped with the management server 10, the vehicle 20, and the portable terminal 30. The management server 10, the in-vehicle machine 200, and the portable terminal 30 can communicate with one another in a wireless manner.

The management server 10 carries out reservation management for the vehicle 20 that is used by a user. The management server 10 accepts a reservation for utilizing the vehicle 20 from the user, via the portable terminal 30. Incidentally, the management server 10 may be a server that provides various services such as an authentication key service, a trunk delivery service, a B2C car share service and the like.

The vehicle 20 is used by a user who made a reservation in advance. The vehicle 20 is mounted with the in-vehicle machine 200 that can communicate with the management server 10 and the portable terminal 30 in a wireless manner.

The in-vehicle machine 200 is, for example, a navigation device. In the case where the in-vehicle machine 200 is a navigation device, the in-vehicle machine 200 displays a map and an own vehicle position on a display through the use of positional information and map data with the aid of a Global Navigation Satellite System (GNSS). Incidentally, the in-vehicle machine 200 may not necessarily be the navigation device, but may be an audio device, a visual device or the like, or a device having the functions of these devices. In the case where the in-vehicle machine 200 is an audio device, the in-vehicle machine 200 receives TV airwaves and radio airwaves and outputs sounds and images thereof, plays back music data stored in a compact disc (CD) and a digital versatile disc (DVD) and outputs the music thereof, or receives music data stored in the portable terminal 30 and outputs the music thereof from a speaker that is mounted in the vehicle 20.

Incidentally, although not shown in FIG. 1, the pieces of equipment that are mounted in the vehicle 20 include an inverter, a motor electronic control unit (ECU), a hybrid ECU, an engine ECU, a motor, auxiliaries and the like as well. The auxiliaries include an air-conditioner, a radiator fan, a rear defogger and the like. Besides, the pieces of equipment that are mounted in the vehicle 20 include various sensors as well. The various sensors include a voltage sensor that detects a voltage that is input from a storage battery to the inverter, a voltage sensor that detects a voltage that is input from the inverter to the motor, a speed sensor that detects a vehicle speed, an accelerator sensor that detects an accelerator depression amount, a brake sensor that detects a brake operation amount, and the like as well.

The in-vehicle machine 200 is equipped with a communication circuit that establishes near-field wireless communication with the portable terminal 30 in compliance with the Bluetooth® Low Energy (BLE) communication standard. Incidentally, the communication circuit may be any communication means capable of establishing near-field communication with the portable terminal 30, and may not necessarily be communication means complying with the BLE communication standard. For example, the communication circuit may be communication means complying with a near-field communication standard with a very short communicable distance, for instance, near-field communication (NFC), ZigBee (®), ultra-wide band (UWB) or the like. In this case, the communication circuit may be incorporated at a position close to a surface of a body outside a vehicle interior of the vehicle 20 (e.g., inside a door handle). Thus, the communication circuit can communicate with the portable terminal 30 outside the vehicle interior.

The communication circuit of the in-vehicle machine 200 establishes a state enabling communication with the portable terminal 30 in compliance with a predetermined communication standard, by periodically (e.g., at intervals of several seconds) delivering an advertising packet. The advertising packet includes advertising information. This advertising information includes a universally unique identifier (UUID), a device ID, and the like. The UUID is, for example, an identifier (an in-vehicle machine ID) for uniquely identifying the in-vehicle machine 200 on a piece of software, and is information that is shared by the in-vehicle machine 200 and the portable terminal 30. The communication circuit of the in-vehicle machine 200 transmits an advertising packet as data including the identifier to the portable terminal 30, for example, when an electric power supply of the in-vehicle machine 200 is activated. The portable terminal 30 that has received the advertising packet confirms the UUID and the like included in the advertising packet, and the communication circuit of the in-vehicle machine 200 thereby establishes a state enabling communication between the portable terminal 30 and the in-vehicle machine 200.

The portable terminal 30 transmits reservation information for using the vehicle 20 to the management server 10, through operation by the user, in the information processing system 1. The user is a passenger (a driver, a fellow passenger or the like) or the like of the vehicle 20.

The portable terminal 30 is, for example, a smart phone, a cellular phone, a notebook-sized personal computer (PC), a personal digital assistant (PDA), a personal handy-phone system (PHS), or the like. The portable terminal 30 communicates with the management server 10 through a predetermined communication network (e.g., a cellular phone network, an internet network or the like having a large number of base stations at terminals thereof) in compliance with a wireless communication standard such as global systems for mobile communications (GSM)®, personal digital cellular (PDC), code division multiple access (CDMA), long term evolution (LTE), worldwide interoperability for microwave access (WiMAX) or the like. Incidentally, “the passenger” is also a user of the portable terminal 30 and hence may be referred to as “the user”. The portable terminal 30 can establish near-field wireless communication with the in-vehicle machine 200 of the vehicle 20 in accordance with the above-mentioned wireless communication standard. Near-field wireless communication includes Bluetooth®, wireless local area network (LAN) or the like.

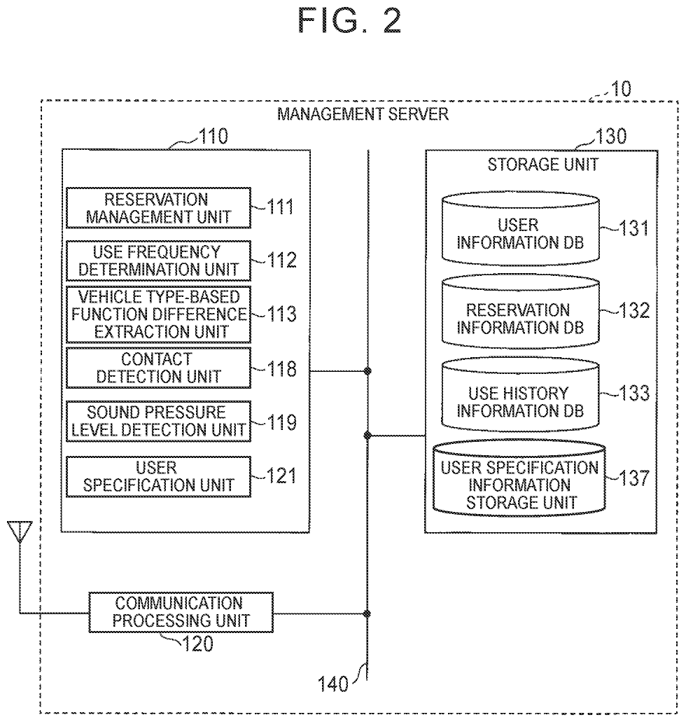

FIG. 2 is a view showing a configuration example of the management server 10. The management server 10 has a control unit 110, a communication processing unit 120, a storage unit 130, and a bus line 140. The control unit 110, the communication processing unit 120, and the storage unit 130 are connected to one another in a communicable manner via the bus line 140.

The control unit 110 is equipped with a reservation management unit 111, a use frequency determination unit 112, a vehicle type-based function difference extraction unit 113, a contact detection unit 118, a sound pressure level detection unit 119, and a user specification unit 121. Besides, the control unit 110 is equipped with a central processing unit (CPU) (not shown), a read only memory (ROM) (not shown), a random access memory (RAM) (not shown), and an input/output interface (not shown). The CPU is a processor that controls the overall operation of the management server 10. A dedicated program for realizing functions of the management server 10 (the reservation management unit 111, the use frequency determination unit 112, the vehicle type-based function difference extraction unit 113, the contact detection unit 118, the sound pressure level detection unit 119, and the user specification unit 121) is stored in the ROM. The RAM is a memory that is used as a work area of the CPU. The CPU realizes the various functions by executing the dedicated program recorded in the ROM, when the electric power supply is turned on.

The reservation management unit 111 accepts a reservation for the use of a vehicle from a user via the portable terminal 30.

The use frequency determination unit 112 makes a determination on a frequency with which the user uses a vehicle type of the car reserved by the user.

The vehicle type-based function difference extraction unit 113 extracts identical functions that are different in operation method between the vehicle type of the car reserved by the user and the vehicle type of the car used by the user with high frequency, and operation methods thereof.

The sound pressure level detection unit 119 has sound information, which is transmitted from a sound collection unit that will be described later, input thereto, and calculates a sound pressure level representing an intensity of the sound, based on this sound information. In concrete terms, the sound pressure level detection unit 119 calculates one of an absolute value of a maximum amplitude in the sound information, an absolute value of an average amplitude in the sound information, a maximum root-mean-square value of an amplitude in the sound information, and a root-mean-square value of the amplitude in the sound information, and calculates this calculated value as a sound pressure level.

The sound pressure level detection unit 119 determines whether or not the calculated sound pressure level has become higher than a predetermined threshold. When it is determined that the sound pressure level has become higher than the predetermined threshold, the sound pressure level detection unit 119 inputs, to the contact detection unit 118, a determination result indicating that the sound pressure level has become higher than the predetermined threshold.

The contact detection unit 118 has distance information, which indicates a value of a distance measured by a ranging unit that will be described later, input thereto, and determines, based on this distance information, whether or not the distance from the vehicle to an object existing around the vehicle has become equal to or zero. The object is a building or the like around the vehicle 20. The building is a construction settled on a land and having a roof and pillars or walls, such as a house, a warehouse, a gate, a wall or the like, a gate and a fence or the like attached to the construction, or an architectural facility. The object existing around the vehicle 20 may be anything that may scratch the surface of the body of the vehicle 20, a bottom surface of the vehicle 20, and the like, and is not limited to the aforementioned ones. In the following description, “the object existing around the vehicle” may be referred to simply as “the object”.

Then, if a result of determination input from the sound pressure level detection unit 119 (determination information indicating that the sound pressure level has become higher than the predetermined threshold) is input to the contact detection unit 118 when it is determined that the distance from the vehicle to the object existing around the vehicle is equal to zero, the contact detection unit 118 detects a contact of the vehicle with the object. A detection result as information indicating detection of the contact of the vehicle with the object is input to the user specification unit 121.

When the contact is detected by the contact detection unit 118, the user specification unit 121 specifies the user of the vehicle whose contact has been detected, based on user identification information as information for identifying the user of the vehicle.

Then, the user specification unit 121 generates table information, and stores the generated table information into the user specification information storage unit 137. The table information is, for example, information obtained by associating timing information on a timing of detection of the contact with user specification information as information representing the user of the vehicle whose contact has been detected.

By associating the timing of detection of the contact with the user specification information, the manager of a car share service or a rental car service can not only specify the user who was driving a certain vehicle at the time of the occurrence of its contact, but also prevents any user other than this user from being falsely accused, by confirming the timing stored in the user specification information storage unit 137, even in the case where the vehicle has been utilized by a plurality of different users during a day.

Incidentally, the table information is not limited to these pieces of information, but may be obtained by, for example, recording only the user specification information in a chronological order without associating the timing therewith. Even the table information thus generated makes it possible to roughly specify the user who was driving the vehicle at the time of the occurrence of its contact, through confirmation of a history of utilization of the vehicle.

Besides, the information processing system 1 according to the present embodiment may be configured to display the user specification information on, for example, a screen of a portable terminal owned by the manager of the car share service or a screen of a terminal device of the car share service. In this case, the user specification information may be stored into the user specification information storage unit 137, or may be simply displayed by the portable terminal or the like without being stored into the user specification information storage unit 137. This is because mere display of the user specification information makes it possible to determine the user of the vehicle at the time of the occurrence of its contact and restrain the memory capacity of the user specification information storage unit 137 from increasing.

The communication processing unit 120 transmits/receives data through wireless communication. The communication processing unit 120 communicates with the vehicle and the portable terminal 30.

The storage unit 130 stores information that is used by the control unit 110. The storage unit 130 includes a user information DB 131, a reservation information DB 132, a use history information DB 133, and a user specification information storage unit 137.

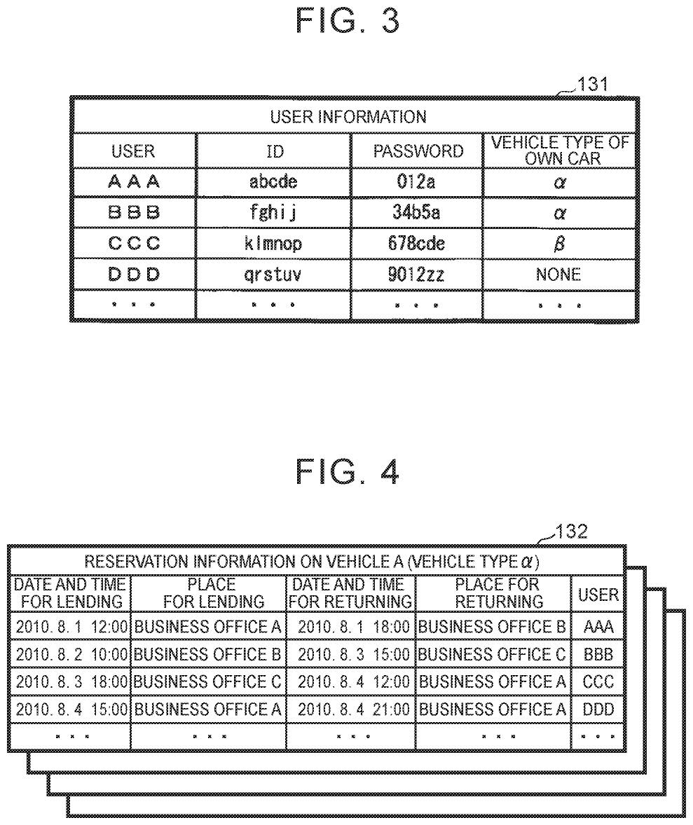

FIG. 3 is a view showing an example of the user information DB 131. The user information DB 131 stores a user ID, a password, a vehicle type of an own car, and the like for each user. The own car is a car that belongs to the user and that is usually used by the user. That is, the own car is a car that is used by the user with high frequency. The name of each user, the user ID, the password, the vehicle type of the own car and the like are stored, in association with the user, in the user information DB 131.

Incidentally, the data that are stored in the user information DB 131 may be input with the aid of, for example, a dedicated application installed in the portable terminal 30. In this case, the data input in the portable terminal 30 are transmitted from the portable terminal 30 to the management server 10. Besides, the data that are stored in the user information DB 131 may be input to a terminal device of a dealer selling the own car. In this case, the data input in the terminal device of the dealer are transmitted from the terminal device of the dealer to the management server 10.

FIG. 4 is a view showing an example of the reservation information DB 132. The reservation information DB 132 stores reservation information on each of a plurality of vehicles. FIG. 4 shows reservation information on a vehicle A (a vehicle type a), and reservation information on three vehicles other than the vehicle A. The reservation information includes a date and time for lending each of the vehicles, a place for lending each of the vehicles, a date and time for returning each of the vehicles, a place for returning each of the vehicles, a name of the user who reserved each of the vehicles, and the like. The date and time for lending each of the vehicles, the place for lending each of the vehicles, the date and time for returning each of the vehicles, and the place for returning each of the vehicles, and the like are stored, in association with the name of the user who reserved each of the vehicles, in the reservation information DB 132. Incidentally, the information that is stored in the reservation information DB 132 is not limited to these pieces of information. The reservation information DB 132 may include, for example, a mail address of the portable terminal 30 of the user who has made a reservation, and the like.

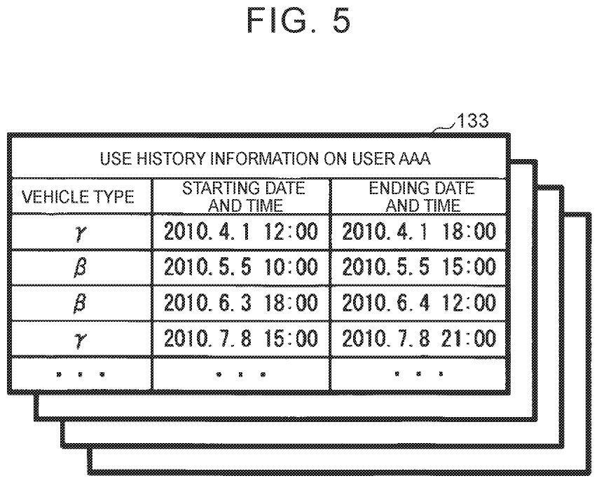

FIG. 5 is a view showing an example of the use history information DB 133. The use history information DB 133 stores use history information on each of the plurality of the users. FIG. 5 shows use history information on a user AAA, and use history information on three users other than the user AAA. A vehicle type of each of the cars used by each of the users in the past, a date and time of the start of utilization of each of the cars, a date and time of the end of utilization of each of the cars, and the like are stored, in association with the name of each of the users who utilized each of the cars, in the use history information DB 133. The number of times of utilization of the vehicle type can be calculated by each of the users, based on the use history information DB 133. Incidentally, the information that is stored in the use history information DB 133 is not limited to these pieces of information. The use history information DB 133 may include, for example, information on the number of times of utilization of each of a plurality of vehicle types.

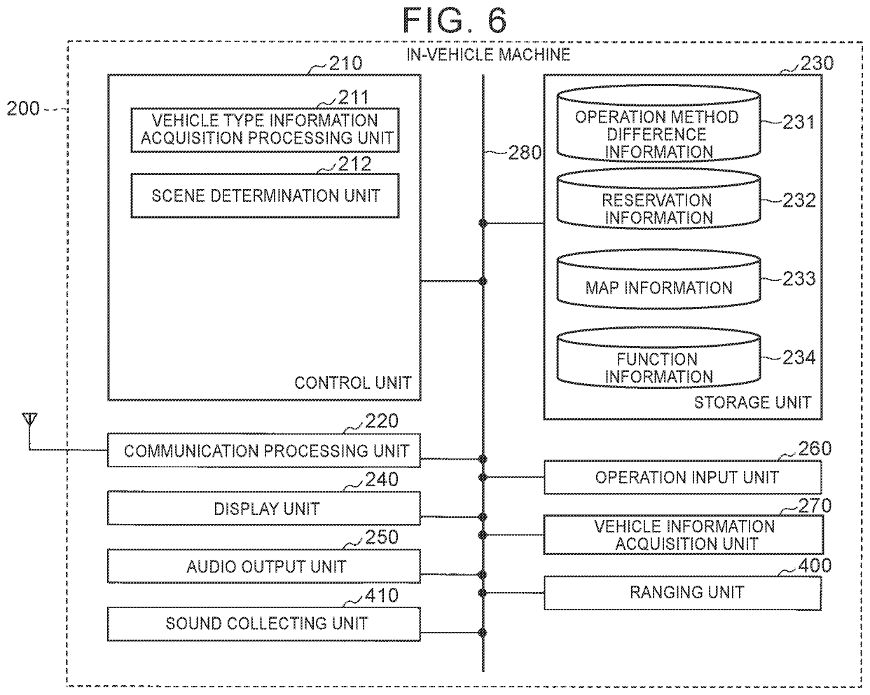

Next, the configuration of the in-vehicle machine 200 will be described using FIG. 6 and the like. FIG. 6 is a view showing a configuration example of the in-vehicle machine 200. The in-vehicle machine 200 is equipped with a control unit 210, a communication processing unit 220, a storage unit 230, a display unit 240, an audio output unit 250, an operation input unit 260, a vehicle information acquisition unit 270, a bus line 280, a ranging unit 400, and a sound collection unit 410. The control unit 210, the communication processing unit 220, the storage unit 230, the display unit 240, the audio output unit 250, the operation input unit 260, the vehicle information acquisition unit 270, the ranging unit 400, and the sound collection unit 410 are connected to one another in a communicable manner via the bus line 280.

The control unit 210 is equipped with a CPU (not shown), a ROM (not shown), a RAM (not shown), and an input/output interface (not shown). The CPU is a processor that controls the overall operation of the in-vehicle machine 200. A dedicated program for realizing functions (a vehicle type information acquisition processing unit 211 and a scene determination unit 212) of the in-vehicle machine 200 is stored in the ROM. The RAM is a memory that is used as a work area of the CPU. When an electric power supply of the CPU is turned on, the CPU realizes the various functions by executing the dedicated program recorded in the ROM.

The vehicle type information acquisition processing unit 211 acquires information on operation methods that are different from one another among the respective functions possessed by the vehicle type of the car that is used by the user with high frequency, from the management server 10 or the portable terminal 30 of the user. The vehicle type information acquisition processing unit 211 stores the acquired information into the operation method difference information DB 231.

The scene determination unit 212 makes a determination on a state of the vehicle and the like, in accordance with information from the vehicle information acquisition unit 270 of the vehicle. The scene determination unit 212 announces an operation method of an appropriate one of the functions, in accordance with the state of the vehicle, through the display unit 240 and the operation input unit 260.

The communication processing unit 220 transmits/receives data through wireless communication. The communication processing unit 220 communicates with the management server 10 and the portable terminal 30. The communication processing unit 220 may transmit/receive data through wired communication. For example, the communication processing unit 220 may be connected to the portable terminal 30 in a wired manner to transmit/receive data thereto/therefrom. The communication processing unit 220 is, for example, a module based on data communication module (DCM) as a communication standard for vehicle use or worldwide interoperability for microwave access (WiMAX) as a wireless communication standard.

The storage unit 230 stores information that is used by the control unit 210 and the like. The storage unit 230 stores an operation method difference information DB 231, a reservation information DB 232, and a map information DB 233.

The ranging unit 400 is a sensor that measures a distance from the vehicle to an object existing around the vehicle. The ranging unit 400 is constituted by, for example, clearance sonars or radar sensors.

The clearance sonars are provided at, for example, a front-right portion and a front-left portion of the vehicle respectively, and also a rear-right portion and a rear-left portion of the vehicle respectively. Each of the clearance sonars transmits ultrasonic waves to a region in front of or behind the vehicle, detects the object existing around the vehicle based on reflected waves of the ultrasonic waves, and outputs sonar information corresponding to a result of the detection. The sonar information includes information representing a distance from a current position of the vehicle to an installation position of the object.

The radar sensors are provided at a front portion and a rear portion of the vehicle respectively. Each of the radar sensors transmits detection waves other than ultrasonic waves (e.g., electromagnetic waves such as millimeter waves, laser or the like) to the region in front of or behind the vehicle, and detects the object existing around the vehicle based on the reflected waves thereof. In the case where laser is used, each of the radar sensors is, for example, laser imaging detection and ranging (LIDAR). Each of the radar sensors outputs radar information corresponding to a result of detection of an obstacle. The radar information includes information representing the distance from the current position of the vehicle to the installation position of the object, information representing a relative speed between the vehicle and the object, and the like.

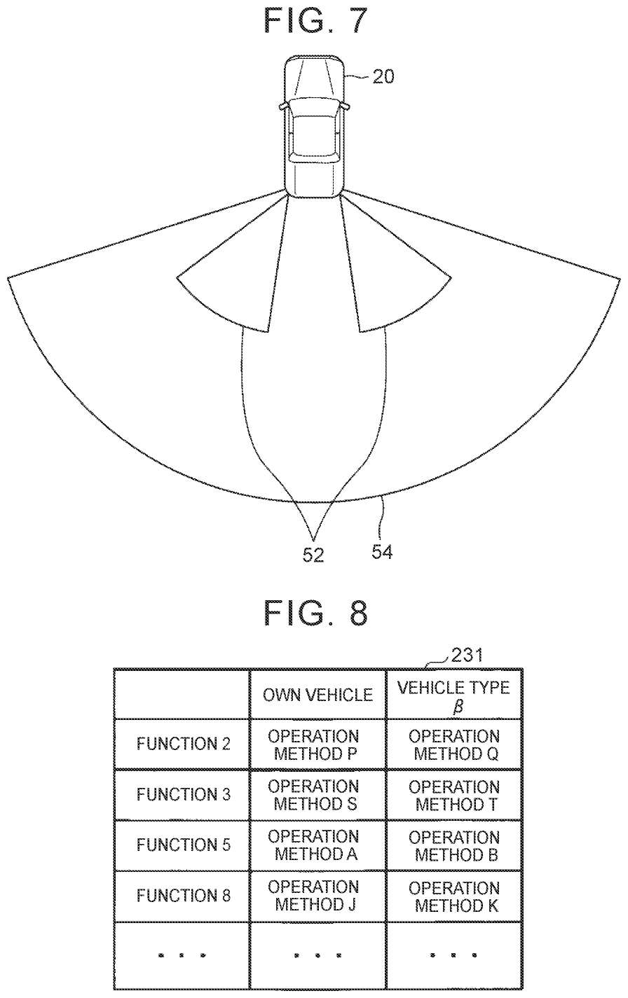

FIG. 7 is a view for illustrating an example of detection regions of the clearance sonars and an example of a detection region of the radar sensors. Detection regions 52 of the clearance sonars and a detection region 54 of the radar sensors overlap with each other. Incidentally, the respective detection regions 52 and 54 shown in FIG. 7 are nothing more than an example. Accordingly, for example, the detection regions 52 may be enlarged to encompass the detection region 54 of the radar sensors, by providing three or more clearance sonars at the rear portion of the vehicle.

Returning to FIG. 6, the sound collection unit 410 is a sound detection microphone that collects a sound around the vehicle, that detects the sound as an oscillatory waveform, and that inputs a signal indicating the detected oscillatory waveform to the sound pressure level detection unit 119 as sound information. The sound around the vehicle is a sound that is produced when the vehicle comes into slight contact with or hits the object existing around the vehicle, or the like. The sound information is input to the sound pressure level detection unit 119 from the in-vehicle machine 200 of the vehicle, via the communication processing unit 120 and the bus line 140 of the management server 10.

The operation method difference information DB 231 stores information on operation methods that are different from one another among the respective functions of the vehicle type of the car that is used by the user with high frequency. An example of information that is stored in the operation method difference information DB 231 will be described using FIG. 8.

FIG. 8 is a view showing an example of the operation method difference information DB 231. The operation method difference information DB 231 can store priorities of operation methods that are different from one another among the respective functions of the vehicle type of the car that is used by the user with high frequency. In the case where the operation methods of the functions are announced, the operation methods with high priorities are announced on a priority basis. The priorities may be determined in advance in the function information DB 234. The operation method difference information DB 231 may store information on operation methods that are identical to one another among the respective functions of the vehicle type of the car that is used by the user with high frequency.

Returning to FIG. 6, the reservation information DB 232 stores the reservation information received from the portable terminal 30.

The map information DB 233 stores map information that is used in providing route guidance in the in-vehicle machine 200. The map information includes information on roads, facilities and the like.

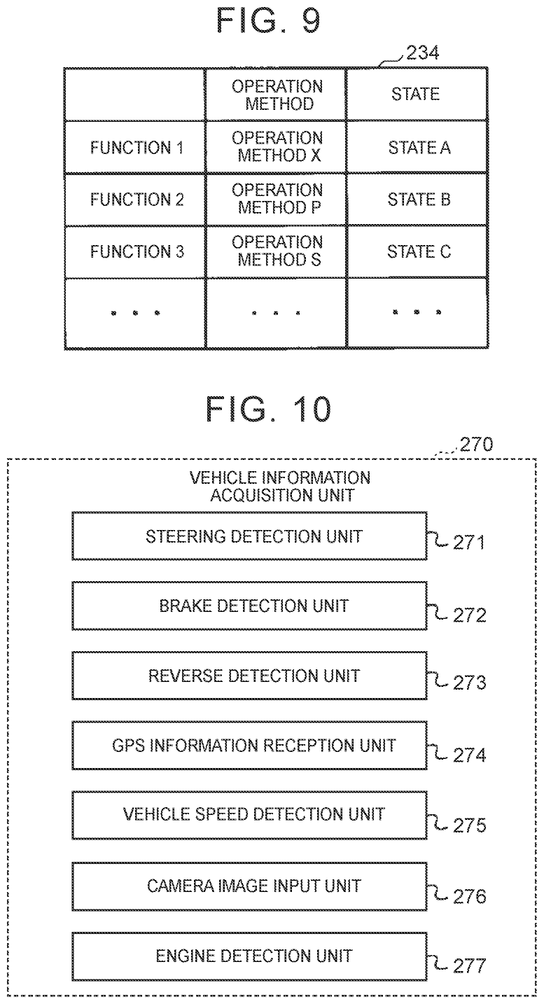

The function information DB 234 stores information on the state of the car or the like at the time when the respective functions of the vehicle are used. The state of the car or the like is, for example, that “an engine of the car has been started”, that “the current position of the car is a petrol station and the car is stopped”, that “a shift lever of the car is at a reverse position”, or the like. An example of information that is stored in the function information DB 234 will be described using FIG. 9.

FIG. 9 is a view showing an example of the function information DB 234. As shown in FIG. 9, the state of the car and the functions of the car to be used in this state are stored, in association with each other, in the function information DB 234. The operation method of the car and the state of the car are stored, in association with each of the plurality of the functions, in the function information DB 234. In the function information DB 234, information on a plurality of states or the like may be stored for one of the functions. The function information DB 234 may have information on the priorities for the respective functions.

Returning to FIG. 6, the display unit 240 performs display based on display screen data or the like that are transmitted from the control unit 210 or the like. The display unit 240 is a display device, for example, a liquid crystal display (LCD), an organic electroluminescence (EL) display, or the like.

The audio output unit 250 carries out the outputting of a voice based on voice data or the like that are transmitted from the control unit 210 or the like. The audio output unit 250 is, for example, a speaker.

The operation input unit 260 accepts a command to the in-vehicle machine 200 from the user. The operation input unit 260 is constituted by, for example, various switches, a touch sensor, an audio input device or the like.

The vehicle information acquisition unit 270 acquires information on the state of the vehicle and the like from sensors and the like in various regions of the vehicle. A configuration example of the vehicle information acquisition unit 270 will be described using FIG. 10.

FIG. 10 is a view showing an example of the vehicle information acquisition unit 270. In the example of FIG. 10, the vehicle information acquisition unit 270 has a steering detection unit 271, a brake detection unit 272, a reverse detection unit 273, a GPS information reception unit 274, a vehicle speed detection unit 275, and a camera image input unit 276. The vehicle information acquisition unit 270 may have other detection units, sensors and the like. The vehicle information acquisition unit 270 may have, for example, a fuel sensor, a coolant temperature sensor, a rain sensor, a road surface sensor, a visibility sensor, an atmospheric pressure sensor, and a light-and-darkness sensor.

The steering detection unit 271 detects a steering pulse signal that is generated in accordance with a rotational angle of a steering wheel. The steering detection unit 271 transmits the detected steering pulse signal to the control unit 210. The steering pulse signal that is detected by the steering detection unit 271 is output, for example, every time the steering wheel rotates by a predetermined angle. The steering detection unit 271 electrically detects the steering pulse signal via a terminal.

The brake detection unit 272 detects whether or not a parking brake of the vehicle is activated. The brake detection unit 272 notifies the control unit 210 of a result of the detection. The brake detection unit 272 detects whether or not the parking brake is activated, based on, for example, an energization state of a switch that turns on/off in accordance with movements of a parking brake lever (or a parking brake pedal). The brake detection unit 272 electrically detects, for example, the energization state of the switch via a terminal.

The reverse detection unit 273 detects whether or not the shift lever (or a speed change lever) of the vehicle is at the reverse (backward) position. The reverse detection unit 273 notifies the control unit 210 of a result of the detection. The reverse detection unit 273 detects whether or not the shift lever is at the reverse position, based on an energization state of a switch that turns on/off in tandem with the shift lever. The reverse detection unit 273 electrically detects, for example, the energization state of the switch via a terminal.

The GPS information reception unit 274 receives signals of electric waves from GPS satellites, which have been received by a global positioning system (GPS) antenna that is connected to a terminal of the GPS information reception unit 274, and transmits the received signals to the control unit 210. The GPS is a system that measures a position of the GPS antenna based on electric waves from at least three GPS satellites among a multitude of GPS artificial satellites orbiting the earth.

In this case, a positioning system using the GPS is applied as a GNSS, but the GNSS is not limited to the GPS. A positioning system using a satellite such as Galileo, a global navigation satellite system (GLONASS) or the like may be used as the GNSS. The GNSS is a positioning system for causing a positioning device mounted in a mobile object to measure a position of the mobile object through the use of signals from satellites.

The vehicle speed detection unit 275 detects a vehicle speed pulse signal that is generated in accordance with a rotational angle of an axle. The vehicle speed detection unit 275 transmits the detected vehicle speed pulse signal to the control unit 210. The vehicle speed pulse signal that is detected by the vehicle speed detection unit 275 is a step-like pulse signal that is output from a vehicle speed sensor or an electronic control unit that controls the engine and brake of the vehicle. The vehicle speed pulse signal is output, for example, every time the axle rotates by a predetermined angle. The relationship between the vehicle speed pulse signal and the moving distance of the vehicle changes depending on the maker that manufactures the vehicle, the vehicle type, the size of wheels fitted to the vehicle, the air pressure in the wheels, and the like. Therefore, the control unit 210 may appropriately correct the vehicle speed derived from the detected vehicle speed pulse signal, based on the moving distance of the vehicle that is calculated based on the result of positioning obtained by the GPS. The vehicle speed detection unit 275 electrically detects the vehicle speed pulse signal via a terminal.

The camera image input unit 276 receives an image signal from a camera (a still camera or a video camera) that photographs the region behind the vehicle. The camera image input unit 276 transmits the received image signal to the control unit 210. The camera image input unit 276 transmits, to the control unit 210, the image signal from the camera that is connected to a terminal of the camera image input unit 276, when the reverse detection unit 273 detects a reverse state of the vehicle.

The engine detection unit 277 detects whether or not the engine is driven. The engine detection unit notifies the control unit 210 of a result of the detection. The engine detection unit 277 detects whether or not the engine is driven, based on, for example, the energization state of the switch that turns on/off in accordance with rotation of the engine. The engine detection unit 277 electrically detects the energization state of the switch via a terminal.

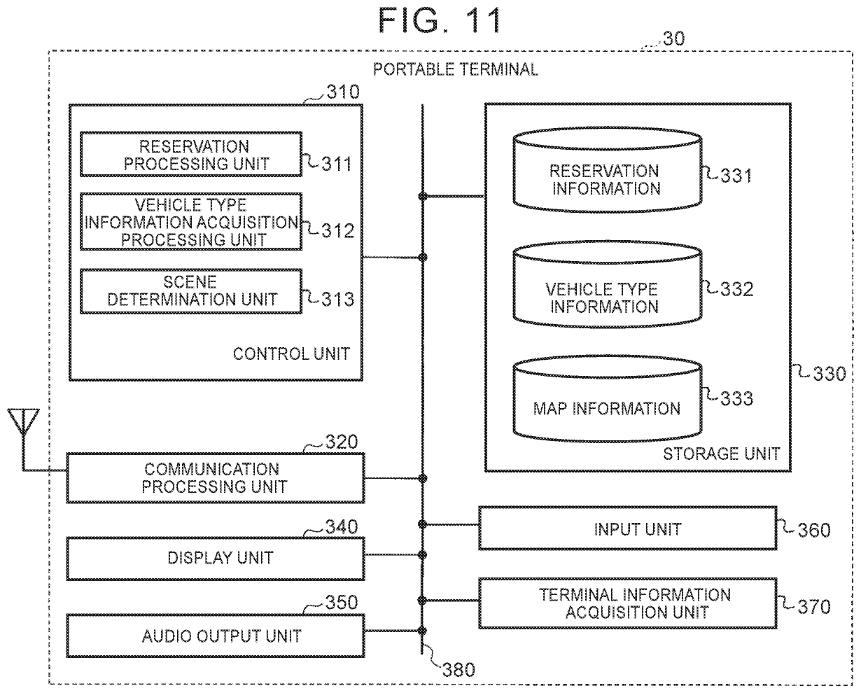

Next, the configuration of the portable terminal 30 will be described using FIG. 11 and the like. FIG. 11 is a view showing a configuration example of the portable terminal 30. The portable terminal 30 is equipped with a control unit 310, a communication processing unit 320, a storage unit 330, a display unit 340, an audio output unit 350, an input unit 360, a terminal information acquisition unit 370, and a bus line 380. The control unit 310, the communication processing unit 320, the storage unit 330, the display unit 340, the audio output unit 350, the input unit 360, and the terminal information acquisition unit 370 are connected to one another in a communicable manner via the bus line 380.

The control unit 310 is equipped with a CPU (not shown), a ROM (not shown), a RAM (not shown), and an input/output interface (not shown). The CPU is a processor that controls the overall operation of the portable terminal 30. A dedicated program for realizing functions (a reservation processing unit 311, a vehicle type information acquisition processing unit 312, and a scene determination unit 313) of the portable terminal 30 is stored in the ROM. The RAM is a memory that is used as a work area of the CPU. When the electric power supply of the CPU is turned on, the CPU realizes the various functions by executing the dedicated program recorded in the ROM.

The reservation processing unit 311 accepts a reservation for the utilization of a vehicle from the user, and performs a process of reserving the utilization of the vehicle by the user on the management server 10.

The vehicle type information acquisition processing unit 312 receives operation methods for operating the functions of the vehicle from the management server 10, and stores the operation methods into the vehicle type information DB 332.

The scene determination unit 313 makes a determination on the state of the vehicle and the like, in accordance with information (position information and acceleration information) and the like from the terminal information acquisition unit 370, map information, and the like. The scene determination unit 313 announces an operation method for operating an appropriate one of the functions in accordance with the state of the vehicle, through the display unit 340 and the audio output unit 350.

The communication processing unit 320 transmits/receives data through wireless communication. The communication processing unit 320 communicates with the management server 10 and the vehicle. The communication processing unit 320 may transmit/receive data through wired communication. For example, the communication processing unit 320 is connected to the vehicle in a wired manner to transmit/receive data thereto/therefrom.

The storage unit 330 stores information that is used by the control unit 310. The storage unit 330 is equipped with a reservation information DB 331, a vehicle type information DB 332, and a map information DB 333.

The reservation information DB 331 stores reservation information included in a reservation completion notification received from the management server 10.

The vehicle type information DB 332 stores a vehicle type of a car reserved by the user, and a vehicle type of a car that is used by the user with high frequency. The vehicle type information DB 332 can store operation methods for the functions of each vehicle type. The operation methods for the functions of each vehicle type are acquired from, for example, the management server 10.

The map information DB 333 stores map information that is used in providing route guidance etc. The map information includes information on roads, facilities and the like.

The display unit 340 performs display based on display screen data or the like that are transmitted from the control unit 310 or the like. The display unit 340 is a display device, for example, an LCD, an organic EL display, or the like.

The audio output unit 350 carries out the outputting of a voice based on voice data or the like that are transmitted from the control unit 310 or the like. The audio output unit 350 is, for example, a speaker.

The input unit 360 accepts a command from the user. The input unit 360 is constituted by, for example, various switches, a touch sensor, an audio input device or the like.

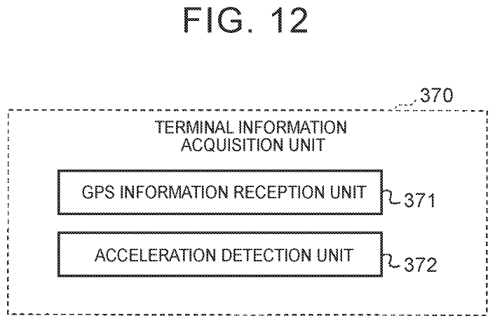

The terminal information acquisition unit 370 acquires information on the state of the portable terminal and the like from sensors and the like in various regions of the portable terminal 30. The configuration of the terminal information acquisition unit 370 will be described using FIG. 12.

FIG. 12 is a view showing an example of the terminal information acquisition unit 370. The terminal information acquisition unit 370 has a GPS information reception unit 371 and an acceleration detection unit 372. The terminal information acquisition unit 370 may have other detection units, sensors and the like.

The GPS information reception unit 371 receives signals of electric waves from GPS satellites, which have been received by a GPS antenna that is connected to a terminal of the GPS information reception unit 371, and transmits the received signals to the control unit 310. The GNSS is not limited to the GPS. A positioning system that uses a satellite such as Galileo, GLONASS or the like may be used as the GNSS.

The acceleration detection unit 372 detects an acceleration pulse signal that is generated in accordance with an acceleration of the portable terminal 30. The acceleration detection unit 372 transmits the detected acceleration pulse signal to the control unit 310. The acceleration pulse signal that is detected by the acceleration detection unit 372 is a pulse signal that is output from an acceleration sensor or the like. An acceleration of the portable terminal 30 is calculated from the acceleration pulse signal. When the acceleration is calculated, a moving speed and a moving distance of the portable terminal 30 are calculated. The acceleration, moving speed and moving distance of the portable terminal 30 located inside the vehicle can be regarded as equal to the acceleration, moving speed and moving distance of the vehicle respectively, unless the portable terminal 30 is violently moved inside the vehicle. The control unit 310 may appropriately correct the acceleration derived from the detected acceleration pulse signal, based on the moving distance of the portable terminal 30 that is calculated based on the result of positioning by the GPS. The acceleration detection unit 372 electrically detects the acceleration pulse signal via a terminal.

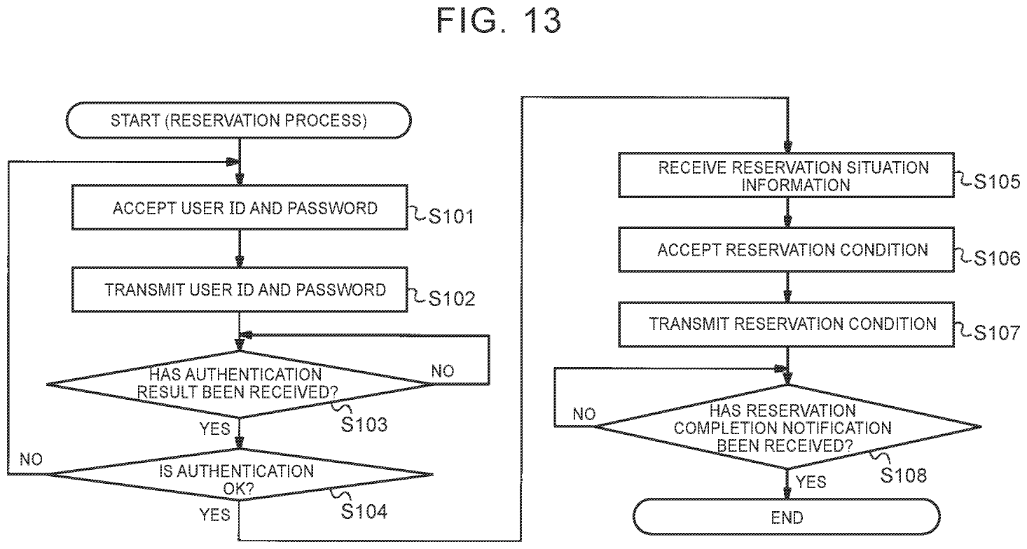

Next, the operation of the portable terminal 30 at the time of reservation will be described using FIG. 13 and the like.

FIG. 13 is a view showing an example of the operation flow of the portable terminal 30 at the time of reservation. FIG. 13 is an example of operation flow in reserving the vehicle 20 to be used by the user. The control unit 310 of the portable terminal 30 executes a computer program that is stored in the storage unit 330, through the turning ON of the electric power supply or the performance of a predetermined operation by the user. The respective function units of the control unit 310 are realized through the execution of this computer program. The operation flow of the reservation process in FIG. 13 is started through actuation of the reservation processing unit 311 of the portable terminal 30, when the user selects a reservation processing function.

The reservation processing unit 311 requires the user to input a user ID and a password (S101). The reservation processing unit 311 causes the display unit 340 to display a message urging the user to input the user ID and the password. The user inputs the user ID and the password by the input unit 360, in accordance with the message displayed by the display unit 340.

When the user ID and the password are input to the reservation processing unit 311, the reservation processing unit 311 transmits the input user ID and the input password to the management server 10, via the communication processing unit 320 (S102). The management server 10 carries out user authentication based on the user ID and password transmitted from the portable terminal 30.

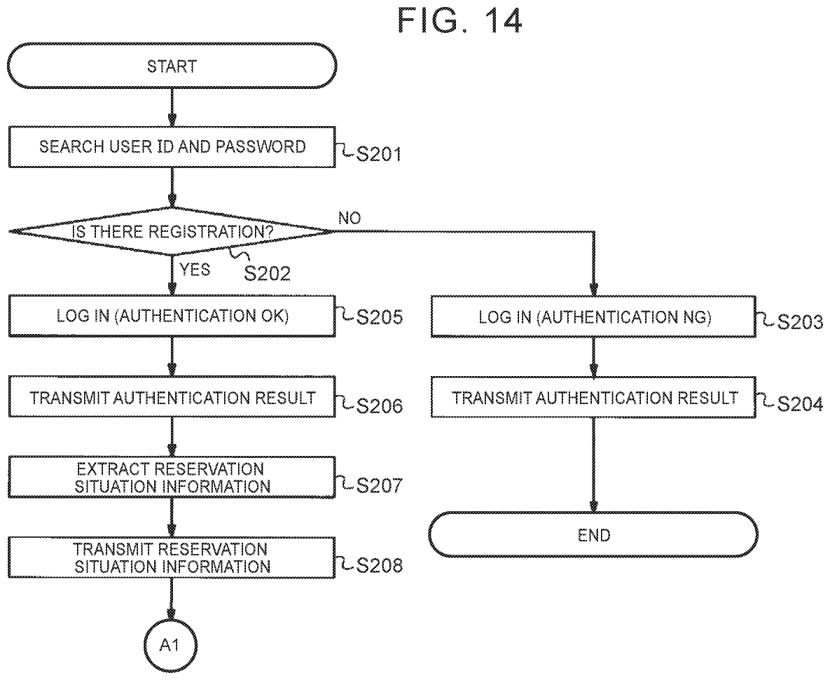

The reservation processing unit 311 stands by until receiving a result of the authentication from the management server 10 (NO in S103). Upon receiving the result of authentication (S204 or S206 of FIG. 14) transmitted by the management server 10 via the communication processing unit 320 (YES in S103), the reservation processing unit 311 determines whether or not the user has been authenticated (S104). If the user has not been authenticated (NO in S104), the processing returns to step S101.

If the user has been authenticated (YES in S104), the reservation processing unit 311 receives reservation situation information (S208 in FIG. 14) transmitted by the management server 10, via the communication processing unit 320 (S105). The reservation situation information includes information on cars (vehicle types) of which the utilization can be reserved at the moment, a period of utilization, a place for lending, a place for returning and the like, in the information processing system 1.

The reservation processing unit 311 accepts a reservation condition from the user (S106). The reservation processing unit 311 causes the display unit 340 to display received reservation situation information. Besides, the reservation processing unit 311 causes the display unit 340 to display a message urging the user to input a reservation condition, based on the reservation situation information. The reservation condition is, for example, a date and time for lending, a place for lending, a date and time for returning, a place for returning, a vehicle type for use, and the like. The user inputs the reservation condition by the input unit 360, in accordance with the message displayed by the display unit 340.

When the reservation condition is input to the reservation processing unit 311, the reservation processing unit 311 transmits the input reservation condition to the management server 10 via the communication processing unit 320 (S107). The management server 10 performs a reservation process based on the reservation condition transmitted from the portable terminal 30, and transmits a reservation completion notification to the portable terminal 30.

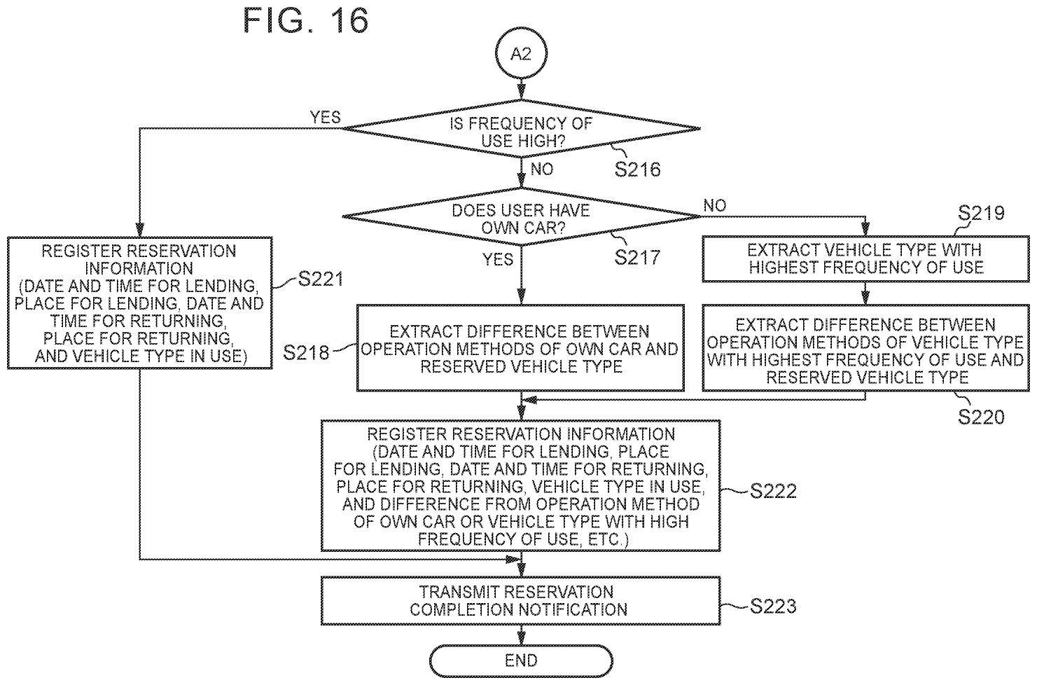

The reservation processing unit 311 stands by until receiving the reservation completion notification from the management server 10 (NO in S108). Upon receiving the reservation completion notification (S223 of FIG. 16) transmitted by the management server 10 via the communication processing unit 320 (YES in S108), the reservation processing unit 311 stores the reservation completion notification received from the management server 10 into the reservation information DB 331 of the storage unit 330, as reservation information. Then, the operation flow of the reservation process is ended. The reservation completion notification (reservation information) includes a date and time for lending, a place for lending, a date and time for returning, a place for returning, and a vehicle type for use. Besides, the reservation completion notification (reservation information) can include information on operation methods that are different from each other for the same function between the vehicle type of the car that is used by the user with high frequency (or the vehicle type of the car that is owned by the user) and the vehicle type of the reserved car.

By the operation flow of FIG. 13, the user can reserve the utilization of the vehicle through the portable terminal 30. The information on operation methods that are different from each other for the same function between the vehicle type of the car that is used by the user with high frequency (or the vehicle type of the car that is owned by the user) and the vehicle type of the reserved car can be stored into the reservation information DB 331 of the storage unit 330 of the portable terminal 30.

Next, the operation of the management server 10 at the time of reservation will be described using FIGS. 14 to 16.

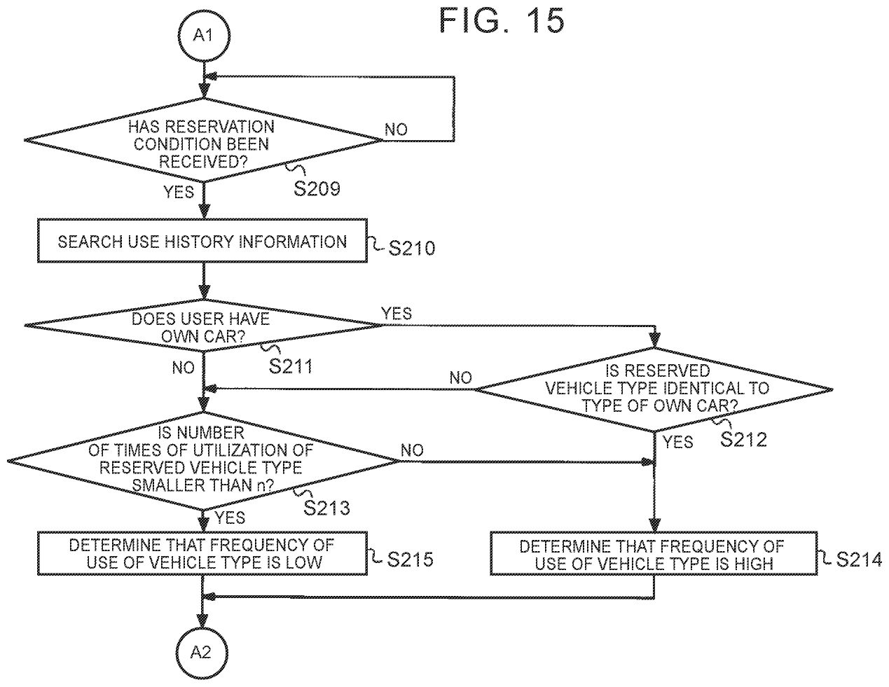

FIG. 14 is a view showing the first operation flow of the management server 10 at the time of reservation. FIG. 15 is a view showing the second operation flow of the management server 10 at the time of reservation. FIG. 16 is a view showing the third operation flow of the management server 10 at the time of reservation. “A1” of FIG. 14 is connected to “A1” of FIG. 15. “A2” of FIG. 15 is connected to “A2” of FIG. 16.

The control unit 110 of the management server 10 executes a computer program stored in the storage unit 130, through the turning ON of the electric power supply. The respective function units of the control unit 110 are realized by executing this computer program. The operation flow of FIGS. 14 to 16 is started through actuation of the reservation management unit 111 of the management server 10 when the user ID and the password are input thereto from the portable terminal 30.

The reservation management unit 111 of the management server 10 receives the user ID and password (S102 of FIG. 13) transmitted by the portable terminal 30, via the communication processing unit 120. The reservation management unit 111 conducts a search through the user information DB 131 of the storage unit 130, using the received user ID as a search key (S201).

If the received user ID does not exist in the user information DB 131, the process proceeds to step S203 on the ground that no user corresponding to the user ID is registered (NO in S202). Besides, if the received user ID exists in the user information DB 131 but the received password is different from the password corresponding to the user ID that is stored in the user information DB 131, the process proceeds to step S203 as in the case where no user corresponding to the user ID is registered (NO in S202). In step S203, the reservation management unit 111 determines that the user cannot be authenticated with the received user ID and password (authentication NG). The reservation management unit 111 transmits, to the portable terminal 30, a result of authentication indicating that authentication is not possible (authentication NG) (S204), and the process is ended.

On the other hand, if the received user ID exists in the user information DB 131 and the received password coincides with the password corresponding to the user ID that is stored in the user information DB 131, the process proceeds to step S205 on the ground that the user corresponding to the user ID is registered (YES in S202), and the process proceeds to step S205. In step S205, the reservation management unit 111 determines that the received ID and password are authenticated (authentication OK). The reservation management unit 111 transmits, to the portable terminal 30, a result of authentication indicating that authentication is successful (authentication OK) (S206).

The reservation management unit 111 extracts reservation situation information from the reservation information DB (S207). The reservation situation information includes information on cars (vehicle types) of which the utilization can be reserved at the moment, a period of reservation for utilization, a place for lending, a place for returning and the like, in the information processing system 1. The reservation management unit 111 transmits the extracted reservation situation information to the portable terminal 30 via the communication processing unit 120 (S208).

The reservation management unit 111 stands by until receiving the reservation condition from the portable terminal 30 (NO in S209 of FIG. 15). In the case where the reservation management unit 111 cannot receive the reservation condition from the portable terminal 30 even after the lapse of a predetermined time, the reservation management unit 111 may end the process.

The reservation management unit 111 receives the reservation condition transmitted by the portable terminal 30 (S107 of FIG. 13) via the communication processing unit 120 (YES in S209).

Subsequently, the use frequency determination unit 112 makes a determination on the frequency with which the user corresponding to the user ID uses the car (the vehicle type) reserved by the user. The use frequency determination unit 112 conducts a search through the use history information DB 133, using the user ID as a search key (S210). The use frequency determination unit 112 acquires a use history of the car of the user corresponding to the user ID. The use frequency determination unit 112 conducts a search through the user information DB 131, using the user ID as a search key, and acquires a vehicle type of the own car of the user corresponding to the user ID (and whether or not this user owns a car).

The use frequency determination unit 112 confirms whether or not the user owns a car (S211). If the user owns a car (YES in S211), the use frequency determination unit 112 confirms whether or not the vehicle type of the car reserved by the user is identical to the vehicle type of the user's own car (S212). If the vehicle type of the car reserved by the user is identical to the vehicle type of the user's own car (YES in S212), the use frequency determination unit 112 advances the process to S214.

If the user does not own any car (NO in S211) or if the vehicle type of the car reserved by the user is not identical to the vehicle type of the user's own car (NO in S212), the use frequency determination unit 112 determines, based on the history of use of the car by the user, whether or not the number of times of the user's utilization of the vehicle type of the car reserved by the user is smaller than the predetermined number of times (n times) (S213). If the number of times of utilization by the user is smaller than the predetermined number of times (n times) (YES in S213), the process proceeds to step S215. If the number of times of utilization by the user is equal to or larger than the predetermined number of times (n times) (NO in S213), the process proceeds to step S214. The use frequency determination unit 112 may adopt, as a criterion for determination, whether or not the number of times of utilization for a past predetermined period up to the present is larger than the predetermined number of times. Besides, the use frequency determination unit 112 may regard a case where the vehicle type of the car reserved by the user is periodically utilized, as being the same etc. as a case where the number of times of utilization by the user is equal to or larger than the predetermined number of times (n times), based on the history of use of the car by the user.

In step S214, the use frequency determination unit 112 determines that the vehicle type reserved by the user is a vehicle type that is used by the user with high frequency. On the other hand, in step S215, the use frequency determination unit 112 determines that the vehicle type reserved by the user is a vehicle type that is used by the user with low frequency. These determination results can be stored into the storage unit 130.

The vehicle type-based function difference extraction unit 113 confirms whether or not the vehicle type reserved by the user is the vehicle type that is used by the user with high frequency (S216 of FIG. 16). If the vehicle type reserved by the user is the vehicle type that is used by the user with high frequency (YES in S216), the process proceeds to step S221. If the vehicle type reserved by the user is the vehicle type that is used by the user with low frequency (NO in S216), the process proceeds to step S217.

The vehicle type-based function difference extraction unit 113 confirms whether or not the user owns a car (S217). If the user owns a car (YES in S217), the vehicle type-based function difference extraction unit 113 extracts functions of the vehicle type of the user's own car and operation methods for operating the functions, and functions of the vehicle type of the car reserved by the user and operation methods for operating the functions, from, for example, a vehicle type-based operation method DB (not shown). Vehicle type-based operation method information on a vehicle type a and vehicle type-based operation method information on vehicle types other than the vehicle type a are stored into the vehicle type-based operation method DB. In the vehicle type-based operation method information, information on the operation methods for operating the plurality of the functions that are provided in the car is recorded for each of the vehicle types of the cars. For example, information indicating a model year of the vehicle type a, information indicating the functions that are provided in the vehicle type a, and information indicating an operation method of an operation unit that sets or operates the functions is associated with the vehicle type-based operation method information on the vehicle type a. Incidentally, instead of the information indicating the model year of the vehicle type a, information indicating a grade of the vehicle type a may be associated with the vehicle type-based operation method information. Alternatively, both the information indicating the model year of the vehicle type a and the information indicating the grade of the vehicle type a may be associated with the vehicle type-based operation method information. This is because any difference in grade leads to a difference in equipment of the vehicle even though the model year remains the same, and hence the specification of the functions and the specification of the operation unit also change depending on the grade. The specification of the functions includes, for example, adjustment of the scale on a map that is displayed on a display screen of the navigation device, adjustment of the volume of audio equipment, actuation or release of the parking brake, activation, release or speed adjustment of cruise control, and the like. The specification of the operation unit includes, for example, the turning of a mechanical dial switch (an operation unit) for navigation that is provided at a center console, the turning of a mechanical dial switch (an operation unit) for audio equipment that is provided at the center console, operation of a lever-type hand brake (an operation unit), operation of a lever-type switch (an operation unit) that is provided on a steering column, and the like.

The vehicle type-based function difference extraction unit 113 extracts the same function that is different in operation method between the vehicle type of the user's own car and the vehicle type of the car reserved by the user, and the operation method thereof, among the extracted functions and the operation methods thereof (S218).

If the user does not own any car (NO in S217), the vehicle type-based function difference extraction unit 113 extracts the vehicle type used by the user with the highest frequency among the vehicle types used by the user, based on the history of use of the cars by the user (S219), and the process proceeds to step S222.

The vehicle type-based function difference extraction unit 113 extracts the functions of the vehicle type extracted in step S219 and the operation methods thereof, and the functions of the vehicle type of the car reserved by the user and the operation methods thereof, from the foregoing vehicle type-based operation method DB. The vehicle type-based function difference extraction unit 113 extracts the same function that is different in operation method between the vehicle type extracted in step S219 and the vehicle type of the car reserved by the user, and the operation method thereof, among the extracted functions and the operation methods thereof (S220), and the process proceeds to step S222.

In step S221, the reservation management unit 111 registers the reservation condition received in step S209 into the reservation information DB 132, as reservation information. The registered reservation information includes information on a date and time for lending, a place for lending, a date and time for returning, a place for returning, and a vehicle type for use.

In step S222, the reservation management unit 111 registers the reservation condition received in step S209 into the reservation information DB 132, as reservation information. The registered reservation information includes the information on the date and time for lending, the place for lending, the date and time for returning, the place for returning, and the vehicle type for use, information on the vehicle type of the car that is used by the user with high frequency (or the vehicle type of the user's own car), and the information extracted in step S218 or step S220. The reservation information may include the result of determination in step S214 or step S215 (the vehicle type that is used with high frequency or low frequency).

The reservation for the utilization of the car by the user is ascertained in step S221 or step S222.

The reservation management unit 111 transmits, to the portable terminal 30, a reservation completion notification including the reservation information stored into the reservation information DB 132 in step S221 or step S222 (S223).

According to the operation flow of FIGS. 14 to 16, the management server 10 can register the reservation for utilization of the vehicle by the user. The management server 10 determines, based on the use's history of use, whether or not the frequency with which the user uses the vehicle type of the vehicle reserved by the user is high. The management server 10 extracts a function that is different in operation method between the vehicle type of the car that is used by the user with high frequency and the vehicle type of the car whose utilization has been reserved by the user. The management server 10 transmits the extracted function and the operation method thereof to the portable terminal 30.

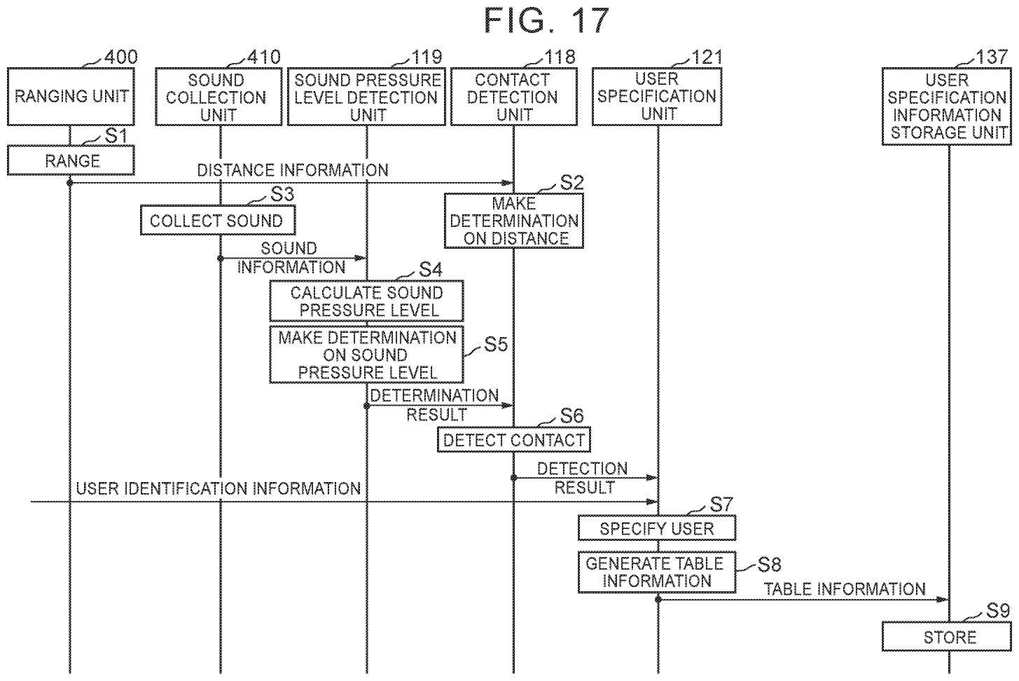

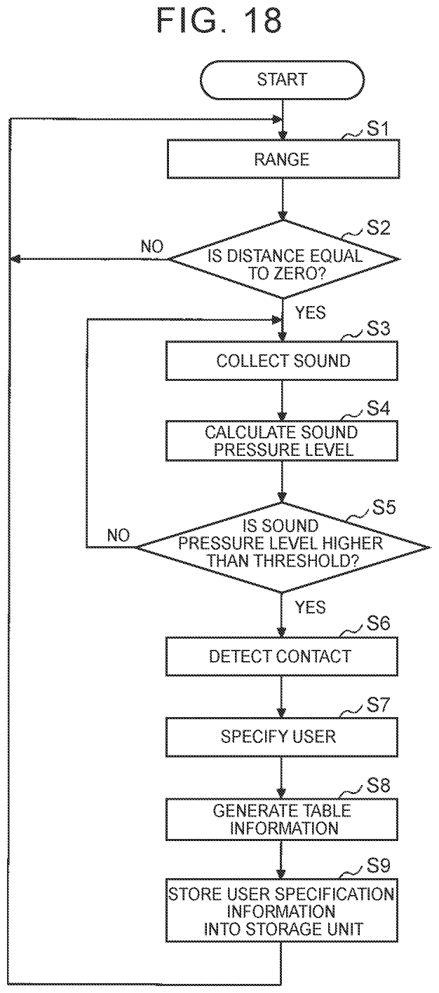

Next, an operation of specifying the user of the vehicle that has come into contact with an object existing around the vehicle will be described using FIG. 17 and the like. FIG. 17 is a sequence chart for illustrating the operation of specifying the user of the vehicle that has come into contact with the object existing around the vehicle. FIG. 18 is a flowchart for illustrating the operation of specifying the user of the vehicle that has come into contact with the object existing around the vehicle.

In step S1, the ranging unit 400 measures a distance from the vehicle to an object existing around the vehicle. Distance information indicating a value of the distance measured by the ranging unit 400 is input to the contact detection unit 118.

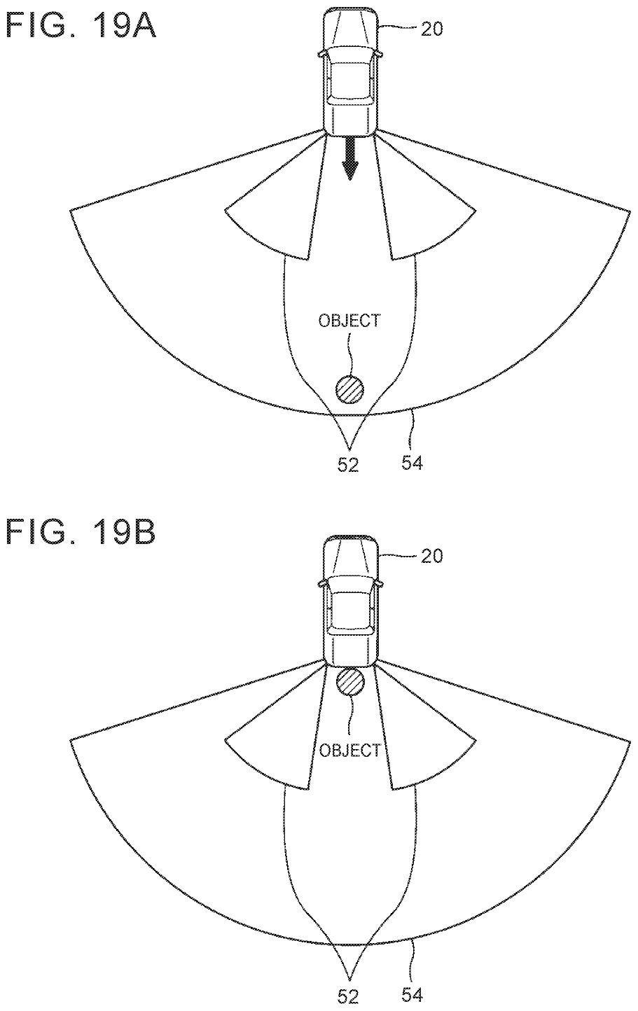

In step S2, the contact detection unit 118 to which the distance information has been input determines, based on the distance information, whether or not the distance from the vehicle to the object existing around the vehicle has become equal to zero. This will be concretely described using FIGS. 19A and 19B.

FIG. 19A is a first view for illustrating a ranging operation and a distance determination operation. FIG. 19B is a second view for illustrating the ranging operation and the distance determination operation. As shown in FIG. 19A, when the vehicle 20 moves backward, the distance from the vehicle 20 moving backward to the object existing behind the vehicle 20 gradually shortens, so the distance that is measured by the ranging unit 400 shortens.

As shown in FIG. 19B, when the vehicle 20 moving backward comes into contact with the object, the distance that is measured by the ranging unit 400 becomes equal to zero. Therefore, the contact detection unit 118 to which the distance information at this time has been input determines that the distance from the vehicle 20 to the object has become equal to zero. Incidentally, even when something that does not scratch the vehicle, for example, the weed existing around the vehicle, a bag that has been blown away by the wind, or the like comes into contact with the vehicle, it can be determined that the distance from the vehicle 20 to the object is equal to zero. The information processing system 1 according to the present embodiment makes a determination on contact through the use of at least one of a later-described sound pressure level and an acceleration, even when something that does not scratch the vehicle comes into contact with the vehicle. Thus, the information processing system 1 according to the present embodiment can prevent any user who will utilize this vehicle later from being falsely accused, even in the case where the vehicle has already got a minor scratch before being utilized.

The processing of step S1 and step S2 is repeated until the contact detection unit 118 determines that the distance from the vehicle to the object has become equal to zero (No in step S2).

When the contact detection unit 118 determines that the distance from the vehicle to the object existing around the vehicle has become equal to zero (Yes in step S2), the processing of step S3 is performed. Incidentally, the processing of step S3 may be performed in parallel with the processing of step S1 and step S2.

In step S3, the sound collection unit 410 collects a sound around the vehicle, and detects the sound as an oscillatory waveform. A signal indicating the detected oscillatory waveform is input to the sound pressure level detection unit 119, as sound information.

In step S4, the sound pressure level detection unit 119 to which the sound information has been input calculates a sound pressure level representing the intensity of the sound, based on the sound information.

In step S5, the sound pressure level detection unit 119 determines whether or not the calculated sound pressure level has become higher than a predetermined threshold.

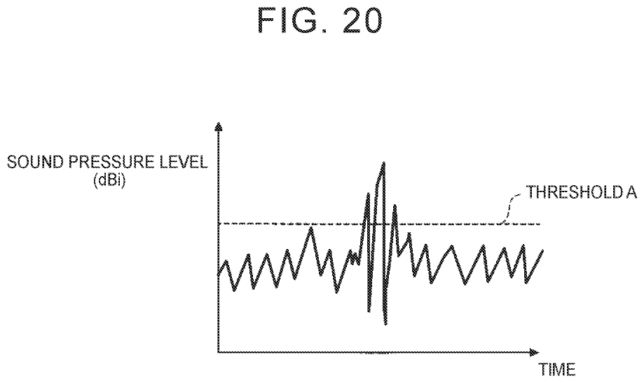

FIG. 20 is a view for illustrating the operation of determining a sound pressure level by the sound pressure level detection unit 119. The axis of abscissa of FIG. 20 represents time, and the axis of ordinate of FIG. 20 represents sound pressure level. As shown in FIG. 20, when the sound pressure level has not become higher than a predetermined threshold A, the processing of steps S3 to S5 is repeated until the sound pressure level becomes higher than the predetermined threshold A (NO in step S5).

The predetermined threshold A is, for example, a value obtained by sampling a sound pressure level of a certain sound a plurality of times in advance for each vehicle type and each vehicle speed. The sound pressure level of the certain sound is, for example, the sound pressure level of a sound that is produced when a vehicle running at low speed in a self-propelled parking lot comes into slight contact with or hits a guardrail, a building or the like, the sound level of a sound that is produced when a vehicle that is about to enter a multilevel parking garage or a garage of a private home comes into slight contact with or hits a guardrail, a building or the like, etc.

When a vehicle moving at high speed hits a building, a vehicle or the like, the vehicle is likely to be seriously damaged. The predetermined threshold A is not set with respect to a sound sampled on the assumption of a scene in which the vehicle is seriously damaged in this manner. The predetermined threshold A is desirably set with respect to a sound pressure level at the time when the vehicle undergoes a serious damage that is only discovered by the manager of, for example, a car share service or a rental car service by checking the vehicle for several to several tens of seconds.

Incidentally, the predetermined threshold A may be any value that enables a determination on the magnitude of the sound pressure level of a sound that is produced when the vehicle comes into contact with an object, and is not limited to the aforementioned ones. The predetermined threshold A may be, for example, information that is stored in advance in the storage unit 130, or information that is delivered from a device outside the management server 10.

If the sound pressure level becomes higher than the predetermined threshold A (Yes in step S5), a determination result indicating that the sound pressure level has become higher than the predetermined threshold A is input to the contact detection unit 118.

In step S6, since the determination result indicating that the sound pressure level has become higher than the predetermined threshold A has been input to the contact detection unit 118 with the distance from the vehicle to the object being equal to zero, the contact detection unit 118 determines that the vehicle has come into contact with the object, and inputs, to the user specification unit 121, a detection result as information indicating that the contact of the vehicle with the object has been detected.

The distance from the vehicle to the object is equal to zero, and the sound pressure level is higher than the predetermined threshold. Therefore, a disturbing sound can be detected separately from the sound produced upon a contact of the vehicle with a guardrail that exists in a parking lot or the like. The disturbing sound is, for example, a running sound that is produced when the vehicle runs on a gravel road, a hurtling sound that is produced when the wind blows at high speed, or the like.

In step S7, the user specification unit 121 to which the detection result as information indicating that the contact of the vehicle with the object has been detected has been input specifies the user of the vehicle whose contact has been detected, based on user identification information.

In step S8, the user specification unit 121 that has specified the user of the vehicle whose contact has been detected generates table information by, for example, associating a timing of detection of the contact with user specification information representing the user of the vehicle whose contact has been detected.

In step S9, the user specification unit 121 stores the generated table information into the user specification information storage unit 137.

As described above, with the information processing system 1 according to the present embodiment, a slight contact of the vehicle running at low speed with the object can be detected by inputting a determination result indicating that the sound pressure level has become higher than the predetermined threshold A to the contact detection unit 118 with the distance from the vehicle to the object being equal to zero.

Besides, the user of the vehicle at the time of the occurrence of such a contact can be managed in a linked manner. Conventionally, there is an apprehension that the user of the vehicle that has come into slight contact may be impossible to specify, that it may be unknown which one of the plurality of the users of the vehicle has scratched the vehicle, and that the locus of responsibility may be unclear. The information processing system 1 according to the present embodiment can specify the user of the vehicle that has come into slight contact. Therefore, the locus of responsibility can be clarified, and the other users can also be prevented from being falsely accused.

Besides, with the information processing system 1 according to the present embodiment, when the sound pressure level is higher than the predetermined threshold, the user of the vehicle that has come into slight contact can be specified. Therefore, the user of the vehicle can be specified without erroneously detecting the contact due to sounds other than the contact sound, for example, a noise that is produced while running on a gravel road, a hurtling sound that is produced when the wind speed is high, and the like.

Modification examples of the information processing system according to the present embodiment will be described hereinafter.

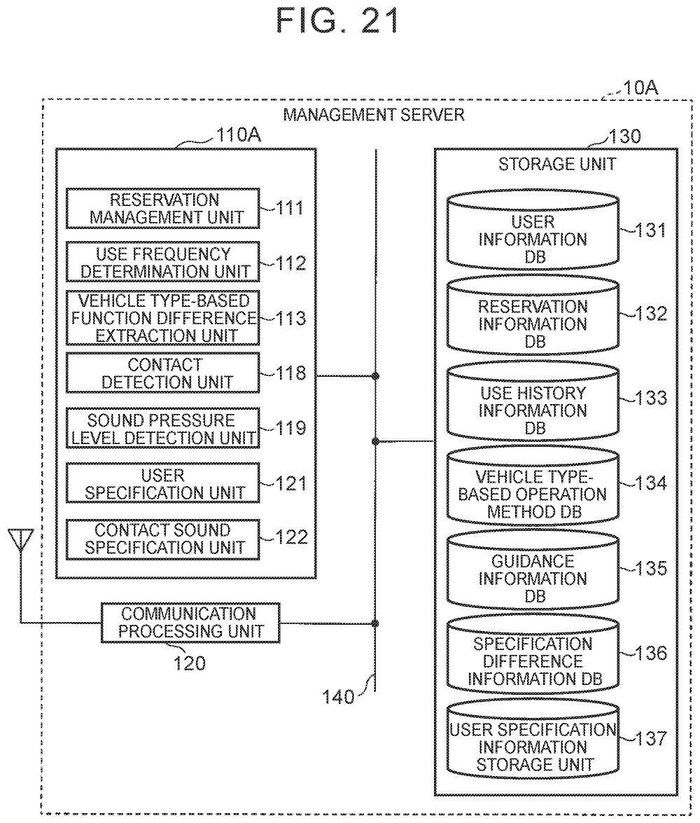

FIG. 21 is a view showing the first modification example of the information processing system 1 according to the present embodiment. A management server 10A of the information processing system 1 according to the first modification example is equipped with a control unit 110A instead of the control unit 110 shown in FIG. 2. The control unit 110A is equipped with a contact sound specification unit 122 in addition to the functions shown in FIG. 2. The contact sound specification unit 122 is a function that is realized through the execution of a dedicated program recorded in a ROM by a CPU constituting the control unit 110A. The contact sound specification unit 122 analyzes a sound collected by the sound collection unit 410, and specifies the sound of contact of the vehicle with the object.

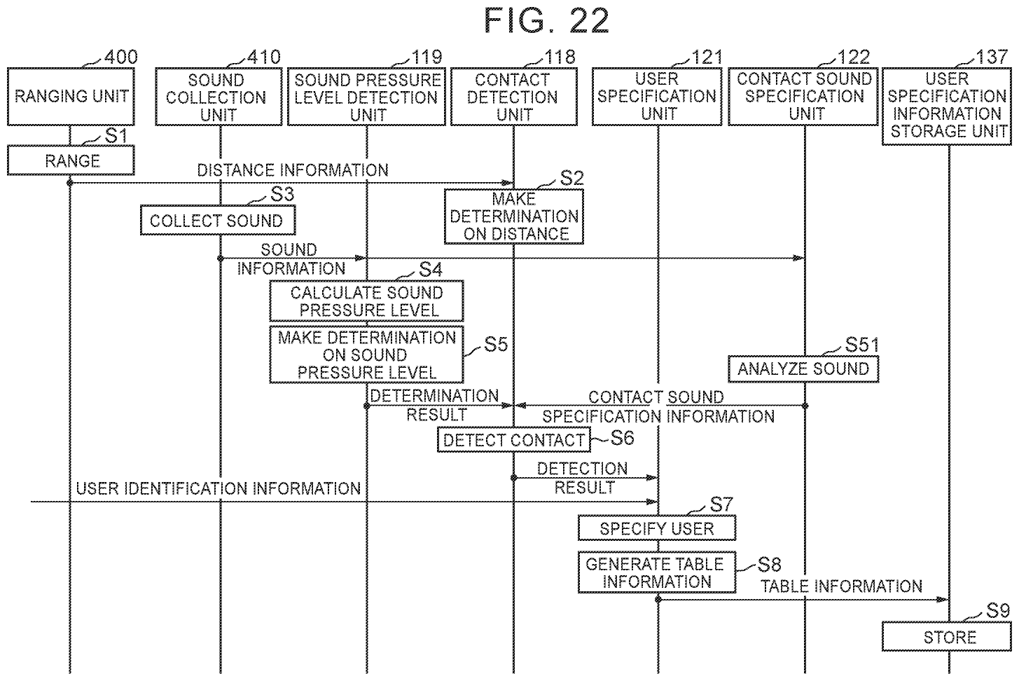

Next, an operation of specifying a user of a vehicle that has come into contact with an object existing around the vehicle in the information processing system 1 according to the first modification example will be described using FIG. 22 and the like.

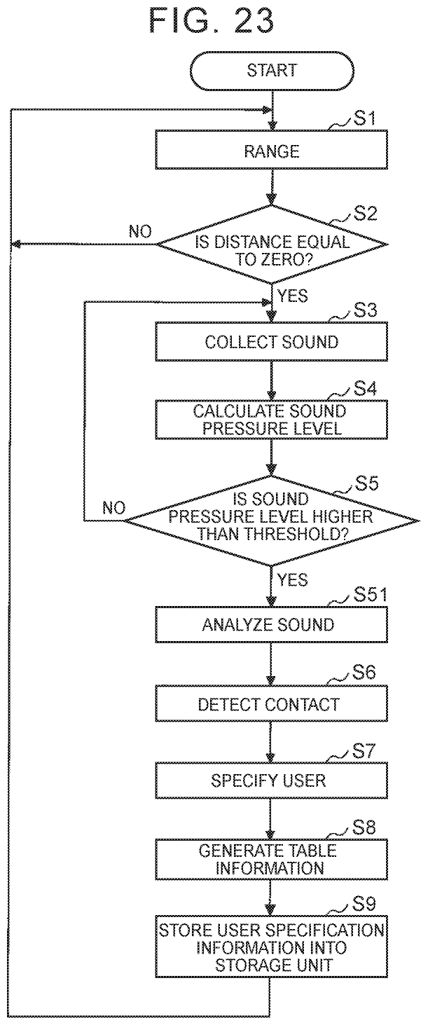

FIG. 22 is a sequence chart for illustrating the operation of specifying the user of the vehicle that has come into contact with the object existing around the vehicle in the information processing system 1 according to the first modification example. FIG. 23 is a flowchart for illustrating the operation of specifying the user of the vehicle that has come into contact with the object existing around the vehicle in the information processing system 1 according to the first modification example.

Only the processing different from the processing of each step number shown in FIG. 17 and FIG. 18 will be described hereinafter.

In step S51, the contact sound specification unit 122 specifies a contact sound that is produced when the vehicle comes into contact with an object, based on sound information input from the sound collection unit 410.

The contact sound specification unit 122 has, for example, a filter that removes a specific register component (a disturbing sound) from data included in the sound information input from the sound collection unit 410, and removes the disturbing sound from the sound collected by the sound collection unit 410 and extracts the contact sound, through the use of the filter. The extracted contact sound is input to the contact detection unit 118 as contact sound specification information, which is information specifying the contact sound.

Incidentally, the method of extracting the contact sound in the contact sound specification unit 122 is not limited to the method using the filter, but may be, for example, a spectral subtraction method or the like.

In step S6, the contact detection unit 118 determines that the vehicle has come into contact with the object by having the determination result indicating that the sound pressure level has become higher than the predetermined threshold A input thereto, and having the contact sound specification information input thereto, with the distance from the vehicle to the object being equal to zero. Then, the contact detection unit 118 inputs, to the user specification unit 121, a detection result as information indicating that a contact of the vehicle with the object has been detected.

As described above, with the information processing system 1 according to the first modification example, the accuracy in detecting the contact is made higher than in the case where only the process of making a determination on the sound in accordance with the sound pressure level is utilized, by extracting the contact sound including no disturbing sound. For example, even in the case where the sound pressure level has become higher than the predetermined threshold because of the closure of the door of another vehicle that is adjacent to the vehicle that is moving backward to be parked, when no contact is detected from the contact sound specification information, the vehicle that is moving backward is not in contact with the object around the vehicle. Accordingly, it turns out that the user of the vehicle is not responsible. Besides, any user who utilizes the vehicle already slightly scratched before his or her utilization can be prevented from being falsely accused.

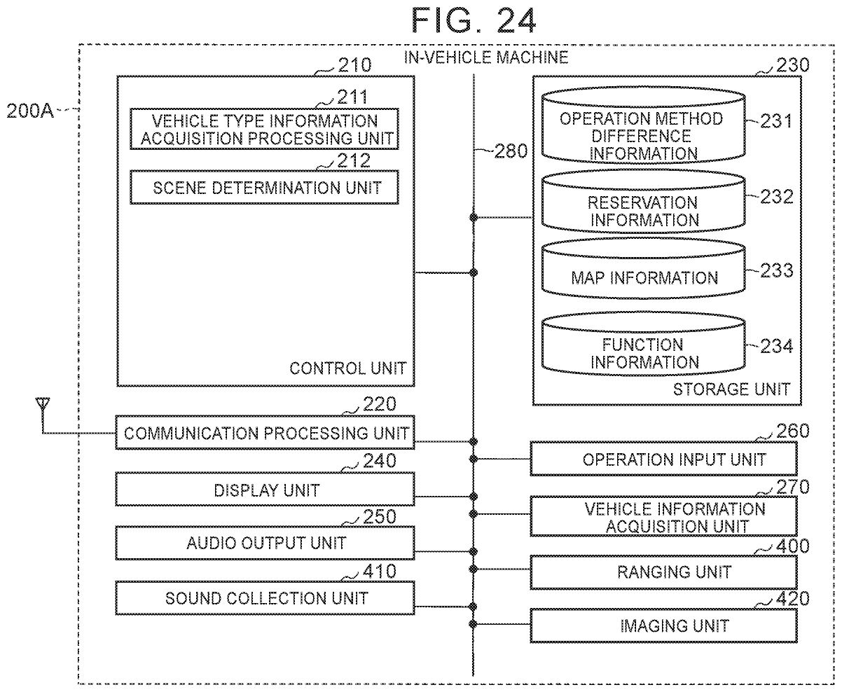

FIG. 24 is a view showing a second modification example of the information processing system 1 according to the present embodiment. An in-vehicle machine 200A of the information processing system 1 according to the second modification example is equipped with an imaging unit 420 in addition to the functions shown in FIG. 6.

The imaging unit 420 is an all-direction camera, a panorama camera or the like that images a landscape near an outer peripheral region of the vehicle. The imaging unit 420 includes, for example, an imaging element such as a charge-coupled device (CCD), a complementary metal oxide-semiconductor (CMOS) or the like. The landscape near the outer peripheral region of the vehicle includes the appearance of a front end portion (e.g., an outer peripheral surface of a front bumper) of the vehicle and a region around this front end portion, the appearance of a rear end portion (e.g., an outer peripheral surface of a rear bumper) of the vehicle and a region around this rear end portion, and the like. The landscape near the outer peripheral region of the vehicle may include the appearance of an outer side of the vehicle in a vehicle width direction thereof.

The vehicle is provided with the single imaging unit 420 or a plurality of imaging units 420. Imaging data representing data on the images imaged by the imaging unit 420 are input to the user specification unit 121 shown in FIG. 2 and the like, via the bus line 280 and the communication processing unit 220.

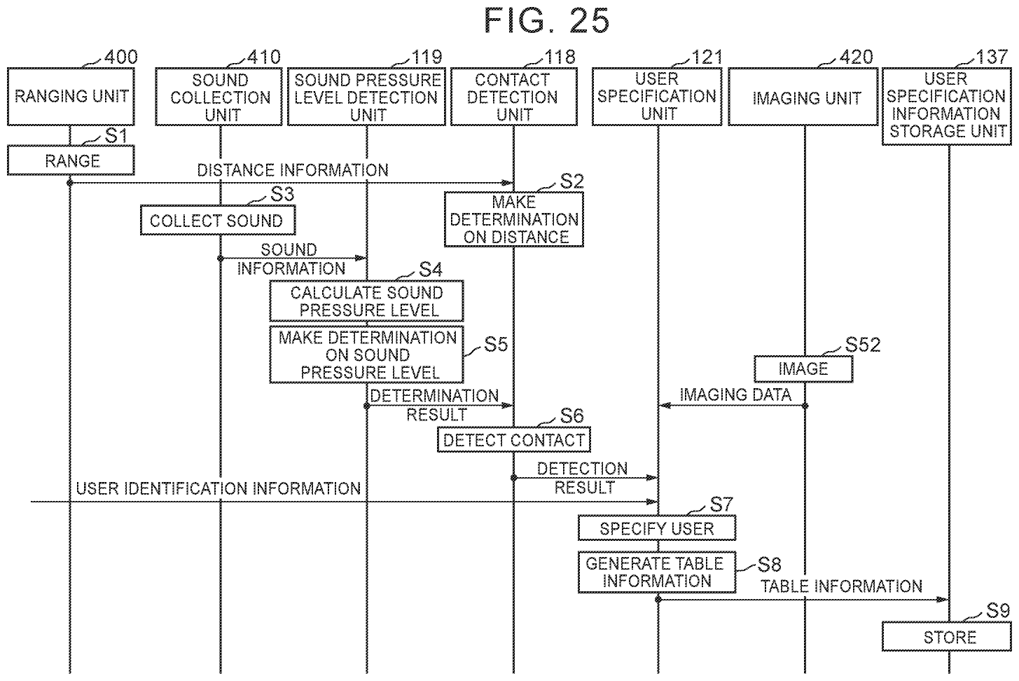

Next, an operation of specifying a user of a vehicle that has come into contact with an object existing around the vehicle in the information processing system 1 according to the second modification example will be described using FIG. 25 and the like.

FIG. 25 is a sequence chart for illustrating the operation of specifying the user of the vehicle that has come into contact with the object existing around the vehicle in the information processing system 1 according to the second modification example.

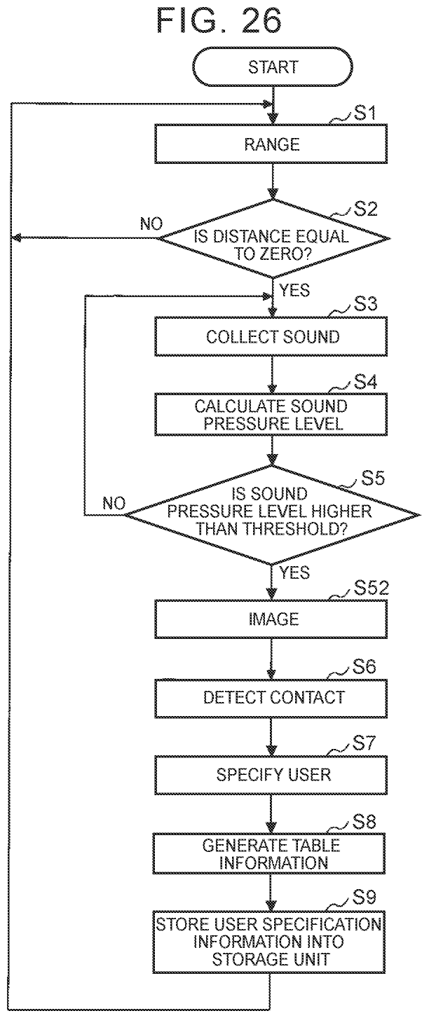

FIG. 26 is a flowchart for illustrating the operation of specifying the user of the vehicle that has come into contact with the object existing around the vehicle in the information processing system 1 according to the second modification example.

Only the processing different from the processing of each step number shown in FIG. 17 and FIG. 18 will be described hereinafter.

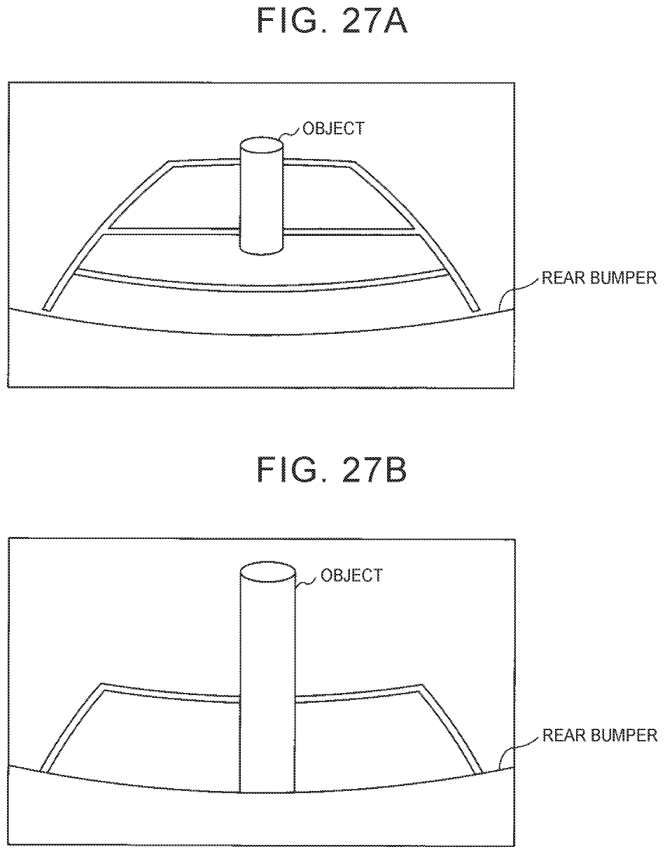

In step S52, the imaging unit 420 images a landscape around the vehicle, and inputs imaging data on the landscape to the user specification unit 121. The landscape that is imaged at this time will be concretely described using FIG. 27A and FIG. 27B.

FIG. 27A is a first view showing a landscape that is imaged by the imaging unit 420. FIG. 27B is a second view showing the landscape that is imaged by the imaging unit 420. As shown in FIG. 27A, there is a columnar object at a position spaced apart from the rear end portion of the vehicle (e.g., the outer peripheral surface of the rear bumper) by a certain distance. When the vehicle moves backward in this state, imaging data that are obtained by imaging how the vehicle moving backward approaches the object are acquired.

As shown in FIG. 27B, when the vehicle moving backward comes into contact with the object (step S6), the contact detection unit 118 determines that the distance from the vehicle to the object has become equal to zero. At this time, the imaging unit 420 acquires the imaging data at the time of the contact of the vehicle with the object.

Then, in step S7, the user specification unit 121 to which the detection result as information indicating that the contact of the vehicle with the object has been detected has been input specifies the user of the vehicle whose contact has been detected, based on the user identification information.

Furthermore, the user specification unit 121 associates the imaging data at the time of the contact of the vehicle with the object with table information, and stores the data into the user specification information storage unit 137.

Incidentally, the configuration of the information processing system 1 according to the second modification example can also be combined with the information processing system 1 according to the first modification example.

As described above, with the information processing system 1 according to the second modification example, the imaging data at the time of detection of the contact can be left. For example, when a disturbing sound with a frequency close to a frequency band of the contact sound is produced around the vehicle, the occurrence of a contact may be erroneously detected. In the information processing system 1 according to the second modification example, an image at the time of erroneous detection of the contact sound can be left. Therefore, by confirming this image, it becomes clear that the user is not responsible.

Besides, an image at the time of the occurrence of an actual contact can be confirmed. Therefore, the manager of share cars or the like can immediately confirm a part that has come into contact. Therefore, the time required for the manager to check is shortened, and the costs of operating a sharing service can be reduced.

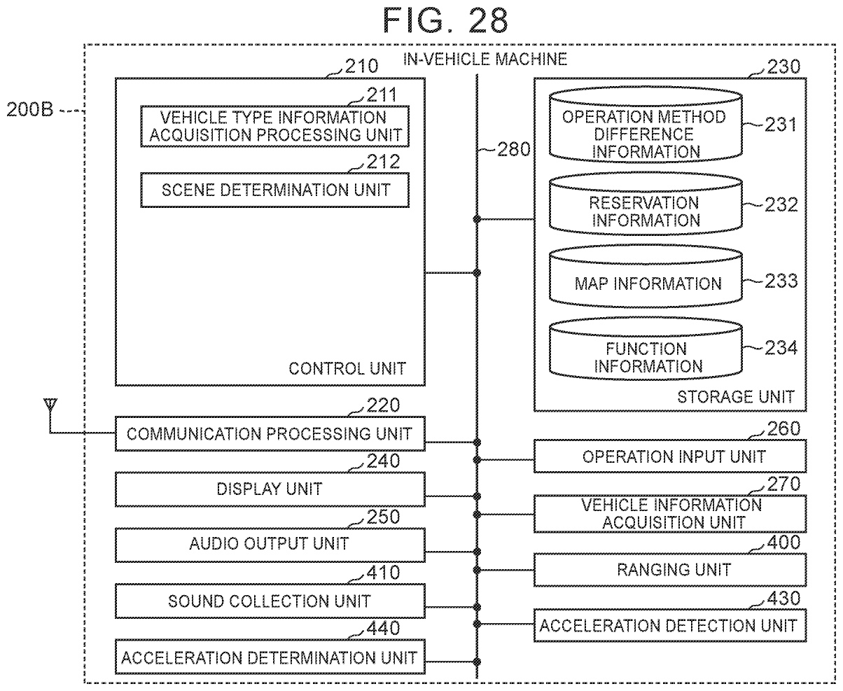

FIG. 28 is a view showing the third modification example of the information processing system 1 according to the present embodiment. An in-vehicle machine 200B of the information processing system 1 according to the third modification example is equipped with an acceleration detection unit 430 and an acceleration determination unit 440 in addition to the functions shown in FIG. 6.

The acceleration detection unit 430 measures, for example, accelerations in an X-axis direction, a Y-axis direction, and a Z-axis direction, which are perpendicular to one another, respectively. Each of these accelerations is a value that is proportional to the acceleration of the vehicle that is mounted with the in-vehicle machine 200B. The acceleration detection unit 430 inputs acceleration information indicating values of the measured accelerations to the acceleration determination unit 440.

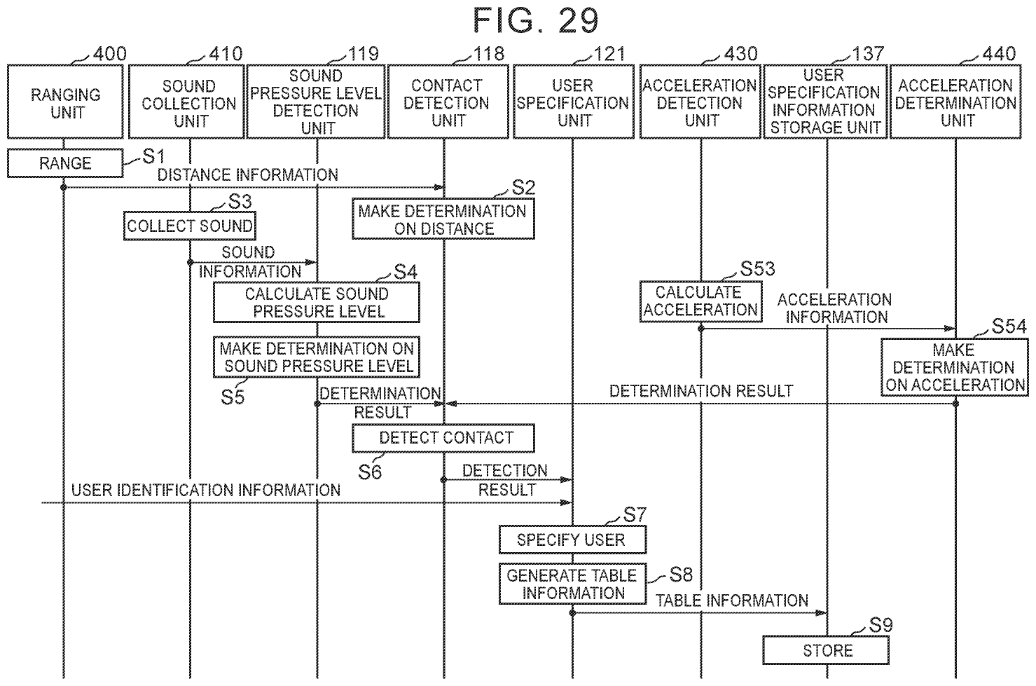

Next, an operation of specifying a user of a vehicle that has come into contact with an object existing around the vehicle in the information processing system 1 according to the third modification example will be described using FIG. 29 and the like.

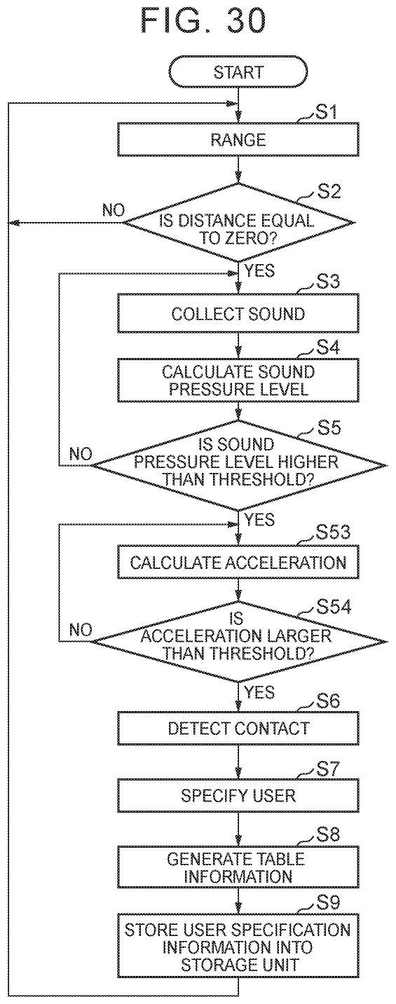

FIG. 29 is a sequence chart for illustrating the operation of specifying the user of the vehicle that has come into contact with the object existing around the vehicle in the information processing system 1 according to the third modification example. FIG. 30 is a flowchart for illustrating the operation of specifying the user of the vehicle that has come into contact with the object existing around the vehicle in the information processing system 1 according to the third modification example.

Only the processing different from the processing of each step number shown in FIG. 17 and FIG. 18 will be described hereinafter.

In step S53, the acceleration detection unit 430 calculates an acceleration, and inputs acceleration information indicating a value of the acceleration to the acceleration determination unit 440.

In step S54, the acceleration determination unit 440 to which the acceleration information has been input determines whether or not the acceleration has become larger than a predetermined threshold.

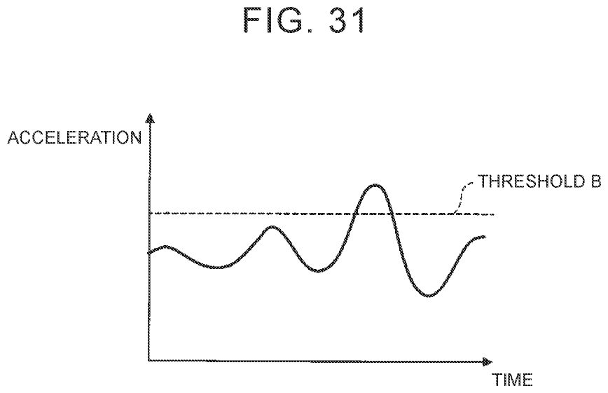

FIG. 31 is a view for illustrating an operation of making a determination on an acceleration by the acceleration determination unit 440. The axis of abscissa of FIG. 31 represents time, and the axis of ordinate of FIG. 31 represents the acceleration that is detected by the acceleration detection unit 430.

As shown in FIG. 31, if the acceleration has not become larger than a predetermined threshold B, the processing of step S53 and step S54 is repeated until the acceleration becomes larger than the predetermined threshold B (No in step S54).

For example, in a scene in which a vehicle with low vehicle height pulls up in a parking space while moving backward, a part of the vehicle that is difficult to visually recognize (a muffler or the like) may come into contact with a curbstone for stopping cars. Besides, when a vehicle that is about to enter a road from a parking lot gets over a step portion provided at a boundary portion between the parking lot and the road, a part of the vehicle that is difficult to visually recognize (a bottom surface of the vehicle or the like) may come into contact with the step portion.

When the vehicle comes into contact with the curbstone or the step portion in this manner, the measured acceleration may become larger than the predetermined threshold B, as shown in FIG. 31.

The predetermined threshold B is a value obtained by, for example, sampling a vibration level at the time when the vehicle hits the curbstone, a vibration level at the time when the vehicle gets over the curbstone or the step portion, or the like in advance a plurality of times for each vehicle type and each vehicle speed.

When a vehicle moving at high speed hits a building, another vehicle or the like, the vehicle is likely to be seriously damaged. The predetermined threshold B is not set with respect to the vibration level sampled on the assumption of a scene in which the vehicle is seriously damaged in this manner.

Incidentally, the predetermined threshold B may be any value that can specify a vibration level (an acceleration) that is generated when the vehicle comes into contact with the object, and is not limited to the aforementioned ones. The predetermined threshold B may be, for example, information that is stored in advance in the storage unit 130, or information that is delivered from a device outside the management server 10.

If the acceleration has become larger than the predetermined threshold B (Yes in step S54), a determination result indicating that the acceleration has become larger than the predetermined threshold B is input to the contact detection unit 118.

In step S6, the contact detection unit 118 determines that the vehicle has come into contact with the object by having the determination result indicating that the sound pressure level has become higher than the predetermined threshold A input thereto, and having the determination result indicating that the acceleration has become larger than the predetermined threshold B input thereto, with the distance from the vehicle to the object being equal to zero. Then, the contact detection unit 118 inputs, to the user specification unit 121, a detection result as information indicating that a contact of the vehicle with the object has been detected.

Incidentally, the configuration of the information processing system 1 according to the third modification example can also be combined with the information processing systems 1 according to the first modification example and the second modification example.

Besides, although the sound pressure level and the acceleration are utilized in combination with each other in the information processing system 1 according to the third modification example, only the acceleration may be utilized. In this case, the information processing system 1 is equipped with the acceleration detection unit instead of the sound pressure level detection unit, and is further equipped with the acceleration determination unit. Then, the contact detection unit detects a contact when the acceleration becomes larger than the predetermined threshold instead of the case where the sound pressure level becomes higher than the predetermined threshold.

As described above, with the information processing system 1 according to the third modification example, the acceleration that is detected when it is determined that the distance is equal to zero can be utilized. Therefore, when a large acceleration is detected because the part of the vehicle that is difficult to visually recognize has hit the curbstone or the step portion, the user specification information can be recorded. Accordingly, even in the case where a lateral surface, the rear bumper or the like of the vehicle is not scratched, the manager of share cars or the like can conduct an inspection of at least the part that is difficult to visually recognize, and take a measure such as a repair or the like of the vehicle, by being informed that the user specification information is recorded. Besides, any user who utilizes the vehicle already slightly scratched before his or her utilization can be prevented from being falsely accused.

Besides, the information processing system 1 according to the present embodiment can share information at respective bases where the sharing service is operated, by being equipped with the server (the management server) that stores the user specification information. Accordingly, the car that has come into contact with something can be immediately confirmed. Therefore, the time required for the manager of share cars or the like to check is shortened, and the costs of operating the sharing service can be significantly reduced.

Besides, the information processing system 1 according to the present embodiment may be configured to store the user specification information only into the in-vehicle machine. Even in the case where the information processing system 1 is thus configured, the user specification information recorded in the in-vehicle machine can be confirmed via, for example, the screen of the navigation device or the like. Besides, the amount of communication resources can be restrained from decreasing, by uploading the user specification information to the management server, and downloading the user specification information from the management server to the respective bases where the sharing service is operated, etc. Thus, the costs of operating the sharing service can be restrained from rising.

Besides, an information processing program according to the present embodiment causes a computer to carry out a step of measuring a distance from a vehicle to an object existing around the vehicle, a step of collecting a sound around the vehicle, a step of detecting a sound pressure level representing an intensity of the sound, a step of detecting a contact of the vehicle with the object when the sound pressure level that is detected when the distance is equal to zero becomes higher than a predetermined threshold, and a step of specifying a user of the vehicle of which the contact has been detected, based on user identification information as information for identifying the user of the vehicle, when the contact is detected.

Besides, the information processing program according to the present embodiment causes a computer to carry out a step of measuring a distance from a vehicle to an object existing around the vehicle, a step of detecting an acceleration of the vehicle, a step of detecting a contact of the vehicle with the object when the acceleration that is detected when the distance is equal to zero becomes higher than a predetermined threshold, and a step of specifying a user of the vehicle of which the contact has been detected, based on user identification information as information for identifying the user of the vehicle, when the contact is detected.

The configuration illustrated in the foregoing embodiment indicates an example of the contents of the disclosure, and can also be combined with other known arts, and can also be partially omitted or altered within such a range as not to depart from the gist of the disclosure.

What is claimed is:

1. An information processing system comprising:
a ranging unit that measures a distance from a vehicle to an object existing around the vehicle;
a sound collection unit that collects a sound around the vehicle;
a sound pressure level detection unit that detects a sound pressure level representing an intensity of the sound;
a contact detection unit that detects a contact of the vehicle with the object when the sound pressure level that is detected when the distance is equal to zero becomes higher than a predetermined threshold; and
a user specification unit that specifies a user of the vehicle of which the contact has been detected, based on user identification information as information for identifying the user of the vehicle, when the contact is detected.

2. The information processing system according to claim 1, wherein
the user specification unit associates timing information indicating a timing of occurrence of the contact with the user specification information as the information for specifying the user of the vehicle of which the contact has been detected, and stores the timing information associated with the user specification information into the storage unit.

3. The information processing system according to claim 1, further comprising:
a contact sound specification unit that analyzes the sound collected by the sound collection unit and that specifies a contact sound of the vehicle with the object, wherein
the contact detection unit detects the contact when the sound pressure level that is detected when the distance is equal to zero becomes higher than the predetermined threshold and the contact sound is specified.

4. The information processing system according to claim 1, comprising, instead of the sound pressure level detection unit:
an acceleration detection unit that detects an acceleration of the vehicle; and
an acceleration determination unit that determines whether or not the acceleration has become larger than a predetermined threshold, wherein
the contact detection unit detects the contact when the acceleration becomes larger than the predetermined threshold, instead of a case where the sound pressure level becomes higher than the predetermined threshold.

5. The information processing system according to claim 1, further comprising:
an acceleration detection unit that detects an acceleration of the vehicle; and
an acceleration determination unit that determines whether or not the acceleration has become larger than a predetermined threshold, wherein
the contact detection unit detects the contact when the sound pressure level that is detected when the distance is equal to zero becomes higher than the predetermined threshold and the acceleration becomes larger than the predetermined threshold.

6. The information processing system according to claim 1, further comprising:
an imaging unit that images an outer peripheral portion of the vehicle, wherein
the user specification unit associates imaging data imaged by the imaging unit with the user specification information as the information for specifying the user of the vehicle of which the contact has been detected, and stores the imaging data associated with the user specification information into the storage unit.

7. The information processing system according to claim 1, further comprising:
a server that stores the user specification information as the information for specifying the user of the vehicle of which the contact has been detected.

8. The information processing system according to claim 1, further comprising:
an in-vehicle machine that stores the user specification information as the information for specifying the user of the vehicle of which the contact has been detected.

9. An information processing program for causing a computer to carry out:
a step of measuring a distance from a vehicle to an object existing around the vehicle;
a step of collecting a sound around the vehicle;
a step of detecting a sound pressure level representing an intensity of the sound;
a step of detecting a contact of the vehicle with the object when the sound pressure level that is detected when the distance is equal to zero becomes higher than a predetermined threshold; and
a step of specifying a user of the vehicle of which the contact has been detected, based on user identification information as information for identifying the user of the vehicle, when the contact is detected.

10. An information processing program for causing a computer to carry out:
a step of measuring a distance from a vehicle to an object existing around the vehicle;
a step of detecting an acceleration of the vehicle;
a step of detecting a contact of the vehicle with the object when the acceleration that is detected when the distance is equal to zero becomes higher than a predetermined threshold; and
a step of specifying a user of the vehicle of which the contact has been detected, based on user identification information as information for identifying the user of the vehicle, when the contact is detected.
